(19) United States
(12) Patent Application Publication
(10) Pub. No.: US 2025/0104106 A1
(43) Pub. Date: Mar. 27, 2025

(54) COMPUTER IMPLEMENTED METHODS FOR GENERATION OF DOCUMENTS WITH PERSONALIZED CONTENT, AND/OR STRATEGY, AND/OR ACTION PLAN

(71) Applicant: MARKTRIX LTD., Herzliya (IL)

(72) Inventors: Shalom MANOVA, Savyon (IL); Naama MANOVA-TWITO, Herzliya (IL)

(21) Appl. No.: 18/730,870

(22) PCT Filed: Feb. 14, 2023
(86) PCT No.: PCT/IL2023/050151

§ 371 Date: Jul. 22, 2024

Related U.S. Application Data
(60) Provisional application No. 63/310,292, filed on Feb. 15, 2022.

(51) Int. Cl. G06Q 30/0203; G06Q 50/00

(52) U.S. Cl. CPC G06Q 30/0203; G06Q 50/01

(57) ABSTRACT

A virtual marketing assistant (VMA) platform including a user interface and processor configured to receive, via the user interface user inputted answers to a questionnaire; analyzing, using a natural language model, the inputted answers and extracting therefrom a plurality of key concepts; automatically extracting data, from the internet and/or at least one application program interface (API), based on the plurality of key concepts; generating a user-specific data repository, the user-specific data repository comprising user specific characteristics, from the extracted data and/or the inputted answers; and applying one or more predictive and generative Machine or Deep learning models on the user-specific data repository to automatically generate a digital marketing action plan and associated content.

### TECHNICAL FIELD

The present disclosure relates generally to computer implemented methods for automated generation of personalized action plans and/or strategy and/or content in various formats, including digital or other.

### BACKGROUND

Today, marketing is an activity that includes processes for generating, communicating, and delivering the value of a company to its customers (or potential customers). Marketing is generally needed for linking the company to the customer and/or prospect. Different marketing techniques can be utilized to reach the goals of the company, such as, for example, increasing revenues, generating opportunities, increasing performance, reaching more clients, increasing satisfaction and loyalty, and branding and positioning of products and services. The different types of techniques that would efficiently work for one specific company may depend upon a plurality of factors, such as, the size of the company, the industry within which it operates, the budget of the company, its goals, the different products and/or services provided by the company to its customers, the characteristics of its target audiences, as well as external factors such as environmental, world and/or political trends.

### SUMMARY

According to some embodiments, there is provided herein a virtual marketing agent/assistant (hereinafter: VMA) tool/platform trained to provide ongoing, proactive, self-initiated and comprehensive full-stack marketing management, planning, creation and execution capabilities to businesses at any size or stage, within any budget and in different channels and methods.

The VMA platform may initially receive first party information (e.g. about the business, the market, the target audience, the team, the competitors, their activities, marketing channels and the like). This information is typically obtained via user inputted answers to a questionnaire, which are then analyzed, using machine learning models, to automatically derive/extract therefrom a plurality of key concepts (parameters) characterizing the business.

According to some embodiments, one or more of the question modules includes one or more questions selected from: requesting the company's name, company's webpage, at least one competitor of the company, the size of the company, business model of the company, return on ad spend of the company, budget of the company, the problem, the solution, existing alternatives, one or more benefits, business goals, key performance indicators (KPIs), vision, challenges, current market, target audiences, and/or any combination thereof.

Then, third party data, such as data about the user, the business, the market, the competitors, the target audience, the content, the performance etc. are then automatically extracted from the internet and/or from at least one application program interface (API).

Based at least on a portion of the plurality of derived key concepts and the collected third party data, the VMA tool compiles a user-specific data repository.

Machine and/or deep learning (ML/Deep) models, optionally also including reinforcement learning models, are then applied on the user-specific data repository, optionally in combination with user inputted business goals (increased sales, increased brand awareness, increasing lead flow or the like) to calculate an action plan, marketing strategy and marketing content with the highest probability of reaching said goals (predictive and/or prescriptive analytics). to 1) output an action plan including channels, frequency, priority, type etc. and 2) to generate the actual content, per each such channel, with the highest probability to yield the desired results, based upon which a full content editorial calendar encompassing the different channels is created.

According to some embodiments, the ML/Deep learning models may be created by auto training based on parameters such as performance, benchmarks, competitor performance, user edits and pre-specified goals. According to some embodiments, custom transformer models optionally based on open-source models, such as GPT-J, that are trained and fine-tuned based on the generated user-specific data repository and/or tagged using human feedback and/or auto collected feedback based on real-time performance and achievement of each piece of content in comparison with predictions and goals (feedback loop). ML/Deep (tabular data) predictive models may be utilized to predict effectivity of at least parts of the generated content plans based on data collected on customers and their competitors actual marketing activities i.e. channel, post type, top performing activities etc.

According to some embodiments, the created content may be in the form of text, video, audio, images or the like and/or any combination thereof. According to some embodiments, the media may be selected and/or modified based on the user's own media library. According to some embodiments, the media may be selected and/or modified based on external media libraries (like Canva). According to some embodiments, the media may be generated by modifying existing media. According to some embodiments, the media may be generated de-novo (e.g. using Dalle-2).

According to some embodiments, the user-specific data repository may be constantly updated with real time data based on:
a. the user can initiate an update to his answers to the questionnaire;
b. the user can periodically be requested to update his/her answers to at least some of the questions in the questionnaire, e.g. on a monthly basis;
c. the VMA continuously collects new/updated 3rd party data;
d. the VMA collects actual performance data from connected 2nd party sources (e.g. google ads, google analytics, email distribution systems, social media insights, etc.)

According to some embodiments, the VMA tool may further periodically evaluate changes in business performance, based on actions taken, plans followed and content used.

According to some embodiments, the action plan and content is proactively updated and executed by the VMA tool, based on the changes in the user-specific data repository and/or changes in performance resulting from previous actions taken or not taken.

According to some embodiments, the VMA tool may be configured to auto trigger initiatives and recommendations, in real-time, based on the user-specific data repository.

Advantageously, the VMA may have autonomous ongoing decision-making, content creation, and management capabilities within a pre-defined “playground”, meaning that it may be able to launch/terminate campaigns, generate/change/update content, shift between channels, etc. ongoingly and on behalf of the user-all within a pre-defined budget and aimed at facilitation of the predetermined business goals. According to some embodiments, the VMA may prepare the content while a final authorization to publish the content is provided by the user.

According to some embodiments, the VMA platform may be directly integrated into 2nd party distribution/media platforms, such as google ads, Facebook, Instagram, mailchimp, canva etc. This advantageously enables the user to execute, publish and manage the plans and content created by the VMA for each channel directly from within the platform. Furthermore, the integration may enable the VMA to collect insights, analytics and performance data and take it into its calculations and decision-making processes for the upcoming activities.

According to some embodiments, the VMA may create all the content for a full editorial calendar (including for example blogs, social media posts, email marketing, articles, advertising campaigns, etc.) and schedule them in advance on a daily, weekly or monthly basis.

Advantageously, the VMA is proactive, i.e. it actively initiates what needs to be done, when, how, why, including proactive creation of all the plans and content in an ongoing manner, such that the user continuously/periodically receives a flow of high quality, personalized, original plans and content designed to progress him/her toward defined goals. To clarify-no prompting or active directions are required from the user in order to create the content in an ongoing manner. The VMA is the researcher and the initiator of the content ideas and the creator of the content without any need for user intervention. The VMA also reinforces its learnings through actively tracking performance of past content created and released to the user, and/or from any edits made by the user to said content such that it continuously adjust, adapts and improves on an autonomous basis.

According to some embodiments, there is provided a virtual marketing assistant (VMA) platform comprising a user interface and processor configured to:
receive, via the user interface user inputted answers to a questionnaire;
analyze, using a natural language model, the inputted answers and extracting therefrom a plurality of key concepts (parameters);
automatically extract data, from the internet and/or at least one application program interface (API), based on the plurality of key concepts;
generate a user-specific data repository, the user-specific data repository comprising user specific characteristics, from the extracted data and/or the inputted answers; and
apply one or more predictive and generative Machine or Deep learning models on the user-specific data repository to automatically generate a digital marketing action plan and associated content.

According to some embodiments, the processor is further configured to executing the action plan via one or more associated execution platforms. According to some embodiments, the processor is further configured to collect performance data from the one or more associated execution platforms and updating the user-specific data repository, based on the collected performance data.

According to some embodiments, the processor is further configured to prompt the user with one or more additional questions and updating the user-specific data repository, based on answers to the one or more additional questions.

According to some embodiments, generating the content for the action plan comprises applying one or more natural language processing (NLP) models on the user data repository to produce an output with personalized marketing content. According to some embodiments, the output is selected from a text document, a blog, an email, an ad, a social media post, investor deck, one pager, company profile, business plan, marketing plan, competitive analysis, swot analysis, financial plan and any combination thereof. Each possibility and combination of possibilities is a separate embodiment.

According to some embodiments, generating the action plan comprises applying a reinforcement learning algorithm on the user-specific data repository.

According to some embodiments, the action plan comprises one or more actions selected from posting on social media, sending an email, uploading/creating a blog, uploading a virtual advertisement or any combination thereof. Each possibility and combination of possibilities is a separate embodiment.

According to some embodiments, generating an action plan comprises selecting one or more channels for publishing the generated content. According to some embodiments, the one or more channels comprise any one or more of a social network, a program, a conference, an email, a blog, an ad, a press release, a message, a media publication, a meeting, or any combination thereof. Each possibility and combination of possibilities is a separate embodiment. According to some embodiments, generating an action plan comprises identifying the best channel, an optimal timing and/or frequency of activity within each channel.

According to some embodiments, the key concepts (parameters) comprise any one or more of: one or more insights on the company, one or more strategies, one or more action plans, one or more marketing content, one or more business goals or any combination thereof. Each possibility and combination of possibilities is a separate embodiment.

According to some embodiments, the extracted data is associated with at least one of: the company of the user, one or more clients/prospects of the company of the user, one or more competitors of the company of the user, the professional field of the user's company, the target market of the company of the user, or any combination thereof. Each possibility and combination of possibilities is a separate embodiment.

According to some embodiments, the extracted data comprises parameters comprising any one or more of: activities of the company of the user, performance of the company of the user, results of the company of the user, activities of one or more competitor companies of the user, performance of one or more competitor companies of the user, results of one or more competitor companies of the user, and/or any combination thereof.

According to some embodiments, generating the user data repository comprises comparing two or more parameters (e.g. 2, 3, 4, 5, 10 or more parameters) of the extracted data. Each possibility is a separate embodiment.

According to some embodiments, the questionnaire comprises a plurality of open-ended questions. According to some embodiments, the questionnaire comprises one or more question modules, wherein each question module comprises one or more different questions. According to some embodiments, the one or more of the question modules comprises one or more questions selected from: requesting the company's name, company's webpage, at least one competitor of the company, the size of the company, business model of the company, funding status, the problem, the solution existing alternatives, one or more benefits, business goals, key performance indicators (KPIs), vision, challenges, current market, and/or any combination thereof. Each possibility and combination of possibilities is a separate embodiment.

According to some embodiments, generating the user data repository comprises applying an expert knowledge module and a reinforcement learning algorithm on the inputted answers.

According to some embodiments, the processor is further configured to update the user data repository by extracting additional data from the internet and/or at least one application program interface (API), based on the plurality of key concepts.

According to some embodiments, the processor is further configured to update the user data repository and/or the output based, at least in part, on the additional extracted data.

According to some embodiments, the processor is further configured to receive, from the user, new and/or adjusted answers to the questionnaire, and updating the key concepts, the repository and/or the output based on the new and/or adjusted answers. Each possibility is a separate embodiment.

According to some embodiments, the output may be a document. According to some embodiments, the document may include, personalized marketing content, and/or marketing strategy and/or action plans for the company of the user, and may be in the form of a document, a digital product, a marketing article and/or a marketing presentation. Each possibility and combination of possibilities is a separate embodiment.

According to some embodiments there is provided herein a computer implemented method for generation of products and outputs (document, blog, email, ad, social media post and the like), with personalized marketing content, and/or strategy, and/or action plan, the method including: receiving an identifying characteristic of a company, automatically extracting, using a machine learning model, data from the internet and/or at least one application program interface (API), based on an identifying characteristic of the company, generating a company data repository including company specific characteristics from the extracted data, applying predictive models on the company data repository to establish actionable insights and/or recommendations, providing a user with one or more products and/or outputs (document, blog, email, add, social media post and the like) including the actionable insights and/or recommendations.

According to some embodiments there is provided herein a computer implemented method for generation of products and outputs (document, blog, email, ad, social media post and the like) with personalized marketing content, and/or strategy, and/or action plan, the method including: receiving user inputted answers to a questionnaire, applying the inputted answers into at least one machine learning algorithm configured to generate one or more insights, strategies and/or action plans based, at least in part, on the user inputted answers, providing the user with one or more products and/or outputs including the actionable insights and/or recommendations.

According to some embodiments, the method further includes applying one or more natural language processing (NLP) models on the user data repository to produce products and/or outputs with personalized marketing content.

According to some embodiments, the user data repository includes any one or more of the user input and/or the extracted data.

According to some embodiments, the user data repository includes any one or more of the user input, data extracted by the API, processed data resulted from one or more analysis, and/or the actionable insights and/or recommendations.

According to some embodiments, the key concepts (parameters) include any one or more of: one or more insights on the company, one or more strategies, one or more action plans, one or more marketing content or any combination thereof.

According to some embodiments, the method further includes generating, using one or more machine learning models, the key concepts (parameters) based, at least in part, on a cross reference of the inputted answers with data associated with any one or more of the type of industry, the type of market, and competitor tracking, or any combination thereof.

According to some embodiments, the extracted data is associated with at least one of: the company of the user, one or more clients/prospects of the company of the user, one or more competitors of the company of the user, the professional field of the user's company, the target market of the company of the user, or any combination thereof.

According to some embodiments, the extracted data includes parameters including any one or more of: activities of the company of the user, performance of the company of the user, results of the company of the user, activities of one or more competitor companies of the user, performance of one or more competitor companies of the user, results of one or more competitor companies of the user, and/or any combination thereof.

According to some embodiments, generating the user data repository includes comparing two or more parameters of the extracted data.

According to some embodiments, the questionnaire includes a plurality of open-ended questions.

According to some embodiments, the questionnaire includes one or more question modules, wherein each question module includes one or more different questions.

According to some embodiments, one or more of the question modules includes one or more questions selected from: requesting the company's name, company's webpage, at least one competitor of the company, the size of the company, business model of the company, return on ad spend of the company, budget of the company, the problem, the solution, existing alternatives, one or more benefits, business goals, key performance indicators (KPIs), vision, challenges, current market, target audiences, and/or any combination thereof.

According to some embodiments, the products and/or outputs are a prescription for marketing strategy.

According to some embodiments, the prescription for marketing strategy (or go-to-market plan) and/or the VMA's channel recommendation includes a recommendation of an action plan for the company, the action plan regarding at least one type of channel for reaching a prospect client and/or a current client.

According to some embodiments, the prescription for marketing strategy (or go-to-market plan) and/or the VMA's channel recommendation includes a recommendation of an action plan for the company of the user, the action plan regarding at least one of: an outline including ideas of what to present through a channel, an optimal time (or range thereof) for using the channel, suggested structure outline, suggested content, or any combination thereof.

According to some embodiments, the channel includes any one or more of a social network, a program, a conference, an email, a blog, an ad, a press release, a message, a media publication, a meeting, or any combination thereof.

According to some embodiments, the product and/or output is a form of marketing content, and/or strategy, and/or action plan which can be a document, a digital product, a marketing article and/or a marketing presentation.

According to some embodiments, the product and/or output is an article with content related to the professional field of the user.

According to some embodiments, the product and/or output includes at least 50 words.

According to some embodiments, the product and/or output is an advertisement.

According to some embodiments, the product and/or output is suitable for posting as a blog and/or as a social media post.

According to some embodiments, the method, further includes utilizing a virtual marketing assistant to prompt the user to input answers in response to the questionnaire, and wherein producing the marketing content, and/or strategy, and/or action plan includes utilizing the virtual marketing assistant to display the produced outputs.

According to some embodiments, the method includes utilizing the virtual marketing assistant to monitor the user and/or to monitor performance of the user in implementation of the action plan provided in the one or more documents, marketing content, and/or strategy, and/or action plan.

According to some embodiments, analyzing the inputted answers and extracting therefrom a plurality of key concepts (parameters) includes applying an algorithm configured to apply text extraction techniques to the inputted answers based, at least in part, on an expert knowledge module.

According to some embodiments, generating the user data repository includes applying an expert knowledge module to the inputted answers, thereby determining priorities of the specific user and/or recommended frequency of activity within each channel.

According to some embodiments, generating the user data repository includes considering the extracted data in the context of events and/or trends.

According to some embodiments, the method further includes updating the user data repository by extracting additional data from the internet and/or at least one application program interface (API), based on the plurality of key concepts.

According to some embodiments, the method further includes updating the user data repository and/or the products and/or outputs based, at least in part, on the additional extracted data.

According to some embodiments, the method further includes receiving, from the user, new and/or adjusted answers to the questionnaire, and updating the key concepts based on the new and/or adjusted answers.

According to some embodiments, the identifying characteristic includes any one or more of the name of the company, the domain of the company, the field of business of the company, or any combination thereof.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In block diagrams and flowcharts, optional elements/components and optional stages may be included within dashed boxes.

In the figures:

FIG. 1A shows a flowchart of functional steps in a computer implemented method for generation of documents, marketing content, and/or strategy, and/or action plan with personalized marketing content, and/or strategy, and/or action plan, in accordance with some embodiments of the present invention;

FIG. 1B shows a flowchart of functional steps in a computer implemented method for generation of documents, marketing content, and/or strategy, and/or action plan with personalized marketing content, and/or strategy, and/or action plan, in accordance with some embodiments of the present invention;

FIG. 2 shows a schematic block diagram of a method for generation of documents, marketing content, and/or strategy, and/or action plan with personalized marketing content, and/or strategy, and/or action plan, in accordance with some embodiments of the present invention; and

FIG. 3 shows a schematic block diagram of a method for generation of documents, marketing content, and/or strategy, and/or action plan with personalized marketing content, and/or strategy, and/or action plan, in accordance with some embodiments of the present invention.

FIG. 4 shows a flowchart of a computer implemented method for generation of a personalized marketing content, strategy, and action plan, in accordance with some embodiments of the present invention.

FIG. 5A shows an exemplary questionnaire of the herein disclosed VMA platform.

FIG. 5B shows an exemplary social media action plan generated by the herein disclosed VMA platform.

FIG. 5C shows an exemplary Google Ads action plan generated by the herein disclosed VMA platform.

FIG. 5D shows exemplary products generated by the herein disclosed VMA platform.

FIG. 5E shows an exemplary an editorial calendar encompassing all action plans and the full planned personal, original content for all channels generated by the herein disclosed VMA platform.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

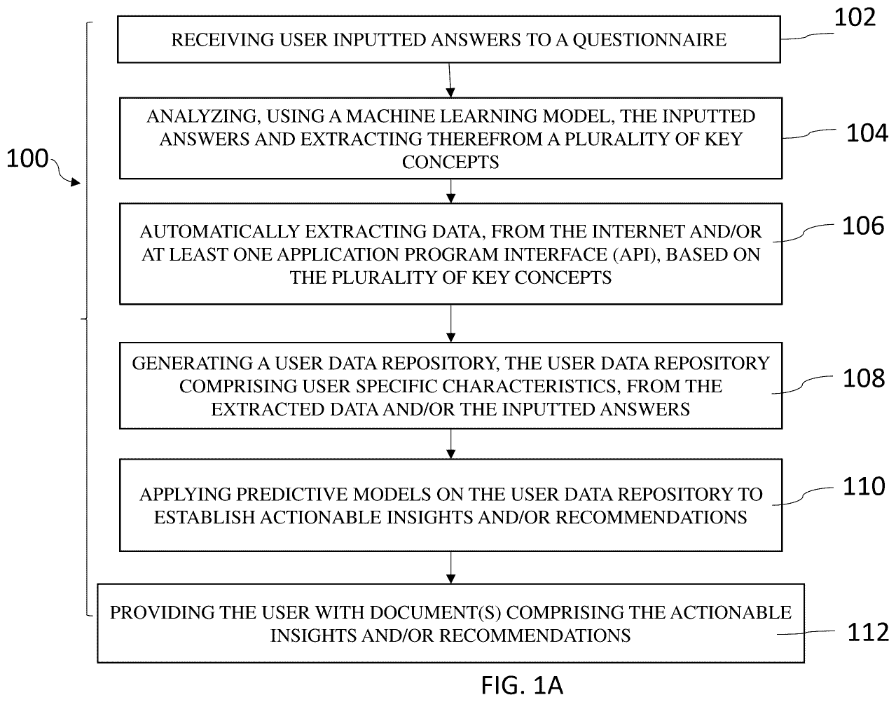

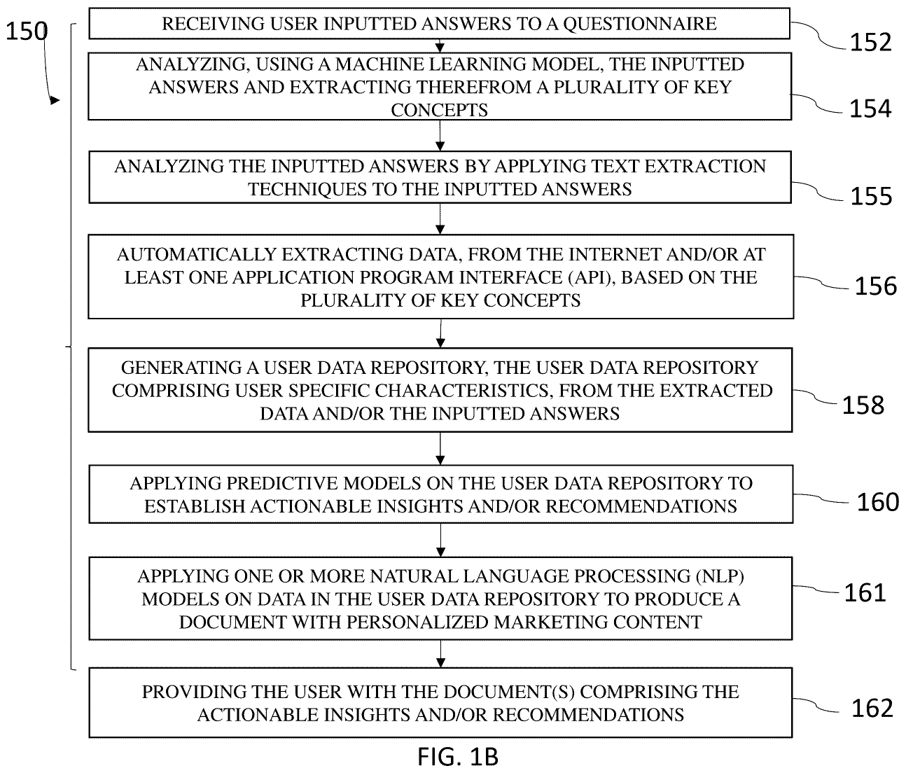

Reference is made to FIG. 1A, which shows a flowchart of functional steps in a computer implemented method for generation of documents marketing content, and/or strategy, and/or action plan with personalized marketing content, and/or strategy, and/or action plan, in accordance with some embodiments of the present invention, and to FIG. 1B, which shows a flowchart of functional steps in a computer implemented method for generation of documents, marketing content, and/or strategy, and/or action plan with personalized marketing content, and/or strategy, and/or action plan, in accordance with some embodiments of the present invention.

According to some embodiments, there is provided a computer implemented method 100/150 for generation of documents, marketing content, and/or strategy, and/or action plan with personalized marketing content, and/or strategy, and/or action plan.

According to some embodiments, at step 102/152, the method 100/150 may include receiving user inputted answers to a questionnaire. According to some embodiments, at step 104/154, the method may include analyzing, using a machine learning model, the inputted answers and extracting therefrom a plurality of key concepts (parameters). According to some embodiments, at step 106/156, the method 100/150 may include automatically extracting data, from the internet and/or at least one application program interface (API), based on the plurality of key concepts. According to some embodiments, at step 108/158, the method may include generating a user data repository, the user data repository including user specific characteristics, from the extracted data and/or the inputted answers. According to some embodiments, at step 110/160, the method may include applying predictive models (e.g., artificial intelligence (AI) predictive) on the user data repository to establish actionable insights and/or recommendations. According to some embodiments, at step 112/162, the method may include providing the user with one or more documents, marketing content, and/or strategy, and/or action plan including the actionable insights and/or recommendations.

According to some embodiments, the term “company” may refer to any one or more of a business, a commercial business, an organization, an individual, a self-employed individual, a virtual company, an online seller, a legal entity, a partnership, and the like. Each possibility is a separate embodiment.

According to some embodiments, the method may include implementing a virtual marketing assistant. According to some embodiments, the virtual marketing assistant may be configured to prompt the user. According to some embodiments, the virtual marketing assistant may be configured to communicate with the user. According to some embodiments, the method may include displaying and/or outputting data to the user using the virtual marketing assistant. According to some embodiments, the method may include receiving data from the user by having the virtual marketing assistant collect the data from the user. According to some embodiments, the method may include utilizing the virtual marketing assistant to prompt the user to input answers in response to the questionnaire. According to some embodiments, producing the document, marketing content, and/or strategy, and/or action plan may include utilizing the virtual marketing assistant to display the produced document, marketing content, and/or strategy, and/or action plan.

According to some embodiments, the method may include utilizing the virtual marketing assistant to monitor the user. According to some embodiments, the method may include utilizing the virtual marketing assistant to monitor performance of the user in implementation of the action plan provided in the one or more documents, marketing content, and/or strategy, and/or action plan. According to some embodiments, the method may include utilizing the virtual marketing assistant to send notifications to the user. According to some embodiments, the method may include utilizing the virtual marketing assistant to remind the user to take action based on the documents (or any one or more of the action plan, marketing content and/or strategy provided in the document (or presented by the virtual marketing assistant).

According to some embodiments, the method may include receiving user input from a user, wherein the user input may be associated with a company of the user. According to some embodiments, the method may include outputting and/or displaying, to a user, one or more options for documents, marketing content, and/or strategy, and/or action plan that can be produced.

As used herein, the term “document” may refer to any type of output and may include, personalized marketing content, and/or marketing strategy and/or action plans for the company of the user, and may be in the form of a document, a digital product, a marketing article and/or a marketing presentation. Each possibility is a separate embodiment. According to some embodiments, the one or more documents may include, but are not limited to, an investor deck, one pager, company profile, business plan, marketing plan, competitive analysis, swot analysis, financial plan (or a budget plan), sales deck, marketing deck, two pager, daily/weekly/monthly/annual: social media plan, content marketing plan, Google ads plan, digital advertising plan, social advertising plan, organic content calendar, email marketing plan, comprehensive editorial calendar and the like. Each possibility is a separate embodiment. According to some embodiments, the one or more documents, marketing content, and/or strategy, and/or action plan may include, but are not limited to, a dynamic document, or in other words, a document that actively updates, such as, for example, a content plan, as described in greater detail elsewhere herein. According to some embodiments, the method may include enabling the user to select one or more options for documents, marketing content, and/or strategy, and/or action plan. According to some embodiments, the method may include receiving data, from the user, associated with one or more selected documents, marketing content, and/or strategy, and/or action plan that are to be produced. According to some embodiments, and as described in greater detail hereinbelow, the method includes producing the one or more selected documents, marketing content, and/or strategy, and/or action plans.

According to some embodiments, the investor deck (or a pitch deck or slide presentation) may refer to a document or a portion of a document that includes a presentation including an overview of the company of the user. According to some embodiments, the investor deck may include a visual component, such as images, design, logos, and the like. Each possibility is a separate embodiment. According to some embodiments, the investor deck may include any one or more of a business plan, one or more products of the company, one or more services of the company, fundraising needs, business model, and key performance indicators of the company, the target market of the company, and the goals of the company, such as the financial goals of the company. According to some embodiments, the investor deck may include a plurality of slides, including one or more slides associated with any one or more of: an introduction, a presentation of the problem that the target market of the business faces, the necessity of the product or service, the target market, the value proposition, the solution provided by the company, the business model, the sale strategy, marketing strategy, the competition, the team of the company, investments, and/or funding. Each possibility is a separate embodiment.

According to some embodiments, the one pager may include a one-page document configured to demonstrate to the reader an overview of the company of the user. According to some embodiments, the one pager may include information associated with one or more products and/or services of the company of the user. According to some embodiments, the one pager may be one or more pages long. According to some embodiments, the one pager may not necessarily refer to a document having exactly one page, but rather a type of document known as a one pager.

According to some embodiments, the two-pager may include a two-page document configured to demonstrate to the reader an overview of the company of the user. According to some embodiments, the two-pager may include information associated with one or more products and/or services of the company of the user. According to some embodiments, the two pager may not necessarily refer to a document having exactly two pages, but rather a type of document known as a two pager.

According to some embodiments, the company profile may refer to a document configured or a portion within a document (e.g., content within a document) to give an overview of the company of the user. According to some embodiments, the company profile may include any one or more of the purposes of the company, the values of the company, the performance of the company, the products and/or services of the company, the unique sales proposition pf the company and the like. Each possibility is a separate embodiment.

According to some embodiments, the business plan may refer to a document or content within a document which is directed to the goals of the company and methods for achieving thereof. According to some embodiments, the business plan may include one or more business goals of the company, one or more methods for achieving the one or more business goals of the company, a time frame for the one or more methods for achieving the one or more business goals of the company, a time frame for each steps within the one or more methods for achieving the one or more business goals of the company, and strategies that can be used in achieving the one or more business goals of the company, an overview of the market, an overview of the competitors, an overview of the opportunity, a SWOT analysis, differentiating advantages of the company, a roadmap, one or more projections, operational needs of the company, financial needs of the company, technical needs of the company, marketing and/or growth needs of the company, and the like. Each possibility is a separate embodiment.

According to some embodiments, the marketing plan may refer to a document or a portion of a document associated with an advertising strategy, for implementation of the user, including details of how to read the target market of the company of the user. According to some embodiments, the marketing plan may include the target market of the company, the value proposition of the company and/or specific products and/or services of the company, and metrics that may be used to measure the effectiveness of the marketing strategy of the company. According to some embodiments, the marketing plan may include an analysis of the ideal buyer persona, one or more channels for reaching the target market and/or content to be provided through the channels. According to some embodiments, the marketing plan may be any one or more of a top-down marketing plan and a bottom-up marketing plan. According to some embodiments, the marketing plan may include a budget.

According to some embodiments, the competitive analysis may refer to a document or a portion of a document associated with competitors of the company. According to some embodiments, the competitive analysis may include a list of one or more competitors of the company. According to some embodiments, the competitive analysis may include an analysis of one or more competitors of the company. According to some embodiments, the competitive analysis may include a chart or graph depicting the type of competition that each competitor provides in relation to the company, when comparing one or more of the products and/or services of the user's company with the competitor's company across various criteria.

According to some embodiments, the swot analysis may refer to a document or a portion of a document associated with the strengths, weaknesses, opportunities, and strengths of the company of the user.

According to some embodiments, the financial plan (or budget plan) may refer to a document or a portion of a document associated with the marketing and/or sales and/or business development budget of the company of the user. Each possibility is a separate embodiment. According to some embodiments, the financial plan may include an extensive (or full) media-spread and/or recommended budget for each channel over time.

According to some embodiments, the marketing deck and/or the sales deck may refer to a document or a portion of a document that includes a presentation including an overview of one or more products and/or services of the company of the user. According to some embodiments, the sales deck may include a visual component, such as images, videos, design, logos, and the like. Each possibility is a separate embodiment. According to some embodiments, the visual component may include one or more depictions of the one or more product and/or service of the company. According to some embodiments, the sales deck may include a sales pitch. According to some embodiments, the marketing and/or sales deck may include detailed description of the unique differentiating advantages of the company of the user. According to some embodiments, the marketing and/or sales deck may include the value proposition of any one or more of the company of the user, one or more products of the company of the user, and one or more services of the company of the user. Each possibility is a separate embodiment. According to some embodiments, the marketing and/or sales deck may include one or more client (or customer) reviews of the company of the user and/or a product and/or a service thereof. Each possibility is a separate embodiment. According to some embodiments, the marketing and/or sales deck may include a client profile for the target clients of the company.

According to some embodiments, the content plan may refer to a document or a portion of a document depicting the planning, development, and/or management of content. According to some embodiments, the content plan may be an active (or dynamic) document, or in other words, and as described in greater detail elsewhere herein, the active document may be intended for regular updates (e.g. a weekly updated action plan). According to some embodiments, the content plan may include advertisement ideas and/or concepts. Each possibility is a separate embodiment. According to some embodiments, the content plan may include one or more channels and/or content to provide via the one or more channels. According to some embodiments, the one or more channels may include, but are not limited to, any one or more of email, in-person meeting, blog port, advertising media, social media, conferences, and the like. Each possibility is a separate embodiment.

According to some embodiments, the content plan may include a textual blog and/or video and/or audio content plan (also referred to hereinafter as the “blog content plan”), which can be used, for example, as a blog, a video blog, a video channel, a web page, a podcast, an audio, and the like, or any combination thereof. Each possibility is a separate embodiment. According to some embodiments, the blog content plan may include ideas and/or concepts for posting in a blog associated with the company of the user. According to some embodiments, the blog content plan may include a schedule for when to post one or more blog posts. According to some embodiments, the blog content plan may include one or more outlines for concepts of content to be posted in the blog. According to some embodiments, the blog content plan may include one or more suggestions for content to be posted in the blog.

According to some embodiments, the content plan may include a search marketing plan. According to some embodiments, the search marketing plan may include ideas and/or concepts for advertisement of the company. According to some embodiments, the search marketing plan may include a schedule for when to post one or more advertisements. According to some embodiments, the search marketing plan may include one or more outlines for concepts to advertise the company of the user. According to some embodiments, the search marketing plan may include one or more suggestions for content to advertise the company of the user.

According to some embodiments, the content plan may include a social media plan, which may include one or more types of content (such as text, video, image, live, gif, and the like, or any combination thereof). Each possibility is a separate embodiment. According to some embodiments, the social media plan may include recommendations and prioritization of at least one social media channel most relevant for the company of the user. According to some embodiments, the social media plan may include ideas and/or concepts for social media posts. According to some embodiments, the social media plan may include organic and/or paid content. Each possibility is a separate embodiment. According to some embodiments, the social media plan may include one or more social media platforms and channels (such as, for example, Facebook, Youtube, Whatsapp, Wechat, Instagram, Twitter, Linkedin, Tiktok, Snapchat, Periscope and the like, or any combination thereof). Each possibility is a separate embodiment. According to some embodiments the social media plan may include one or more types of content (such as, for example, feed, story, live, messenger, and the like). Each possibility is a separate embodiment. According to some embodiments, the social media plan may include a schedule for when to post in the social media. According to some embodiments, the social media plan may include one or more outlines for concepts to post in the social media associated with the company of the user. According to some embodiments, the social media plan may include one or more suggestions for content to post and/or advertise on the social media related to the company of the user.

According to some embodiments, the content plan may include an email plan. According to some embodiments, the email plan may include ideas and/or concepts for emailing from an email associated with the company of the user. According to some embodiments, the email plan may include a schedule for when to email. According to some embodiments, the email plan may include a schedule of who to email. According to some embodiments, the email plan may include one or more outlines for concepts to email. According to some embodiments, the email plan may include one or more suggestions for content to be included in the email to be sent by the company of the user.

According to some embodiments, the content plan may include a Press Release (PR) Plan, which may be used for example for a press release, an article, a media brief, and the like, or any combination thereof). Each possibility is a separate embodiment. According to some embodiments, the PR plan may include ideas and/or concepts for creating media releases associated with the company of the user. According to some embodiments, the PR plan may include a schedule for when to release one or more press releases. According to some embodiments, the PR plan may include one or more outlines for concepts of content to be released to the media. According to some embodiments, the PR plan plan may include one or more suggestions for content to be included in the press release.

According to some embodiments, the content plan may include a Short Message Service (SMS) plan. According to some embodiments, the SMS plan may include ideas and/or concepts for messaging from a messaging service associated with the company of the user. According to some embodiments, the SMS plan may include one or more messaging channels (such as, for example, Whatsapp, Telegram, SMS, and the like, or any combination thereof). Each possibility is a separate embodiment. According to some embodiments, the SMS plan may include a schedule for when to message. According to some embodiments, the SMS plan may include a schedule of who to message. According to some embodiments, the SMS plan may include one or more outlines for concepts to message. According to some embodiments, the SMS plan may include one or more suggestions for content to be included in the message to be sent by the company of the user.

According to some embodiments, the content plan may include an influencer marketing plan, including one or more types of content (such as, for example, text, video, image, live, gif, and the like, or any combination thereof). Each possibility is a separate embodiment. According to some embodiments, the influencer marketing plan may include recommendations and/or prioritization of at least one media channel most relevant for the company of the user. According to some embodiments, the influencer marketing plan may include ideas and/or concepts for influencer content, which can be any one or more of a post, an ad, a blog, a comment, a recommendation, a testimonial and the like, or any combination thereof. Each possibility is a separate embodiment. According to some embodiments, the influencer marketing plan may include an overview outline/brief to be provided to the influencer by the company of the user. According to some embodiments, the influencer marketing plan may include email content to be sent to the influencer by the company of the user. According to some embodiments, the influencer marketing plan may include organic and/or paid content.

According to some embodiments, the influencer marketing plan may include one or more media platforms and channels (such as, for example, Facebook, Youtube, Instagram, Twitter, Linkedin, Tiktok, Snapchat, Communities, Groups, Forums, Conferences, Blogs, Articles, Rankings and the like, or any combination thereof). Each possibility is a separate embodiment. According to some embodiments the influencer marketing plan may include one or more types of content (such as, for example, feed, story, live, messenger, article, ad, testimonial and the like, or any combination thereof). Each possibility is a separate embodiment. According to some embodiments, the influencer marketing plan may include a suggested schedule for when to publish influencer content. According to some embodiments, the influencer marketing plan may include one or more outlines for concepts to post in the media channels associated with the company of the user. According to some embodiments, the influencer marketing plan may include one or more suggestions for content to post and/or advertise on the media channel related to the company of the user.

According to some embodiments, the content plan may be an active (or dynamic) document. According to some embodiments, the content plan may update regularly. According to some embodiments, the content plan may update every day, every other day, every few days, every week, every few weeks, every month, and/or every few months, or any range therebetween. Each possibility is a separate embodiment.

According to some embodiments, the content plan may update based, at least in part, on data from the user data repository. According to some embodiments, the user data repository may include data associated with any one or more the user inputted answers, the extracted data, and/or the analyzed extracted data. Each possibility is a separate embodiment. According to some embodiments, the extracted data, and/or the analyzed extracted data may include data associated with the target market of the company and/or activities of the competitors of the company. Each possibility is a separate embodiment.

According to some embodiments, the method for generation of documents with personalized marketing content, and/or strategy, and/or action plan may include generating documents that are personalized to the user and/or the company of the user. According to some embodiments, the method may include generating printable and/or downloadable documents. According to some embodiments, the method may include generating editable documents. According to some embodiments, the documents may be generated in a variety of formats, including, but not limited to, any one or more of: web-based document format, viewable documents, downloadable documents, editable documents, printable documents or any combination thereof. Each possibility is a separate embodiment. According to some embodiments, the document may include any one or more of a prescription for marketing strategy, a marketing document, a marketing article and/or a marketing presentation. Each possibility is a separate embodiment. According to some embodiments, the documents may include, but are not limited to, any one or more of a marketing content, and/or strategy and/or action plan. Each possibility is a separate embodiment. According to some embodiments, the documents may be associated with inbound and/or outbound and/or brand positioning marketing strategies. According to some embodiments, the documents may be associated with activities within the target market. According to some embodiments, the documents may be associated with any one or more of brand awareness, lead generation and nurturing, customer acquisition and nurturing, customer satisfaction and/or business growth. Each possibility is a separate embodiment.

According to some embodiments, the method may include outputting and/or displaying, to the user, a questionnaire. According to some embodiments, the questionnaire may include one or more questions associated with the company of the user. According to some embodiments, the questions may include any one or more of open-ended questions (such as, for example, text input or free text), single select, multi select, multi-field text input, slider, image, file upload, date and the like or any combination thereof. Each possibility is a separate embodiment.

According to some embodiments, the questionnaire may include one or more question modules, wherein each question module may include one or more different questions. According to some embodiments, the questionnaire may include a plurality of question modules. According to some embodiments, the one or more question modules may include any one or more of an introduction question module, solution question module, business question module, goals question module, financing needs question module, business model question module, market question module, competitors question module, challenges question module, target customers question module, industry type question module, buyer persona question module, and the like. Each possibility is a separate embodiment.

According to some embodiments, each of the one or more question modules may include one or more questions. According to some embodiments, each question module may include different questions therein, such that, for example, combining all of the question modules would not result in any repeating questions. According to some embodiments, the one or more questions may be selected from: requesting the company's name, company's webpage, at least one competitor of the company, the size of the company, business model of the company, funding status, the problem, the solution existing alternatives, one or more benefits, business goals, key performance indicators (KPIs), vision, challenges, current market, and/or any combination thereof. Each possibility is a separate embodiment.

For example, the introduction question module may include one or more questions about the business, for examples, the size of the company, the business model, funding status, website, and competitors of the company. For example, the solution question module may include open ended questions about the solution itself, the problem the company is solving, the existing alternatives, the benefits, and the like. Each possibility is a separate embodiment. For example, the goals question module may require the user to set business goals and/or measurable KPIs.

For example, the business question module may include one or more questions about the business, the team, business status, risk mitigation, positioning, brand assets, and the like. Each possibility is a separate embodiment. For example, the financing needs question module may include one or more questions about the business model of the company, the market, funding status, funding goals, business goals, validation and the like. Each possibility is a separate embodiment. For example, the business model question module may include one or more questions about one or more products and/or services of the company, the target market of the company, the business and revenue model, and the like. Each possibility is a separate embodiment. For example, the market (and competitors) question module may include one or more questions about the current market, the type of industry of the company, one or more names of companies that are competitors of the company, one or more companies providing similar products and/or services, the vision of the company, the challenges the company may be facing, and the like. Each possibility is a separate embodiment.

For example, the challenges question module may include one or more questions about the challenges facing the company, future challenges that may arise, and the like. Each possibility is a separate embodiment. For example, the target customers question module may include one or more questions about characteristics (such as, for example, age, location, income and/or lifestyle) of the people most likely to use the products and/or services of the company. Each possibility is a separate embodiment. For example, the industry type question module may include one or more questions about the field in which the one or more products and/or services of the company can be found. Each possibility is a separate embodiment. For example, the buyer persona question module may include one or more questions about the one or more questions about characteristics (such as, for example, age, location, income and/or lifestyle) of the people most likely to use the products and/or services of the company. Each possibility is a separate embodiment.

According to some embodiments, the method may include outputting, to the user, a plurality of questions by outputting one or more of the question modules. According to some embodiments, the method may include selecting which question modules to output. According to some embodiments, the method may include selecting (and/or calculating) which question modules to combine, using one or more algorithms, such that no question is repeated. According to some embodiments, the method may include selecting (and/or calculating) which question modules to combine for a specific selected document to be produced. According to some embodiments, the method may include selecting (and/or calculating), using one or more algorithms, which question modules to combine for a plurality of specific selected documents to be produced.

According to some embodiments, at step 102/152, the method 100/150 may include receiving user inputted answers to the questionnaire. According to some embodiments, at step 104/154, the method may include analyzing, using a machine learning model, the inputted answers and extracting therefrom a plurality of key concepts (parameters).

According to some embodiments, at step 155, the method may include analyzing the inputted answers by applying text extraction techniques to the inputted answers. According to some embodiments, the method may include analyzing, using a machine learning model, the inputted answers, by applying an algorithm configured to apply text extraction techniques to the inputted answers based, at least in part, on an expert knowledge module. According to some embodiments, the expert knowledge module may be an artificial intelligence (AI) based algorithm. According to some embodiments, the expert knowledge module may be part of one or more algorithms that are described in greater detail elsewhere herein.

According to some embodiments, the method may include generating, using one or more machine learning models, the key concepts (parameters) based, at least in part, on a cross reference of the inputted answers with data associated with any one or more of the type of industry, the type of market, and competitor tracking, or any combination thereof. Each possibility is a separate embodiment. According to some embodiments, the method may include gathering data associated with any one or more of the type of industry, the type of market, and/or the competitors of the company (or competitor tracking). Each possibility is a separate embodiment. According to some embodiments, the method may include gathering data associated with any one or more of the type of industry, the type of market, and/or the competitors of the company, using one or more algorithms. Each possibility is a separate embodiment. According to some embodiments, the method may include gathering data by analyzing the inputted answers, using one or more machine learning models, to determine any one or more of type of industry, the type of market, and/or the competitors of the company. According to some embodiments, the key concepts (parameters) may include any one or more of: one or more insights on the company, one or more strategies, one or more action plans, one or more marketing content or any combination thereof. Each possibility is a separate embodiment.

According to some embodiments, the method may include utilizing one or more platforms configured to track activities of the user, the user's company, one or more clients of the user, and/or one or more prospective clients of the user (or prospects). According to some embodiments, the one or more platforms may include one or more application program interfaces (APIs). According to some embodiments, the method may include tracking various parameters on the activities, performance and results of the user's company and comparable companies.

According to some embodiments, at step 106/156, the method 100/150 may include automatically extracting data, from the internet and/or at least one application program interface (API), based on the plurality of key concepts. According to some embodiments, the method may include extracting data in order to generate the (selected) document. According to some embodiments, the extracted data may be based, at least in part, on the plurality of key concepts.

According to some embodiments, the extracted data may be associated with at least one of the company of the user, one or more clients/prospects of the company of the user, one or more competitors of the company of the user, the professional field of the user's company, the target market of the company of the user, or any combination thereof. According to some embodiments, the extracted data may include one or more parameters including any one or more of: activities of the company of the user, performance of the company of the user, results of the company of the user, activities of one or more competitor companies of the user, performance of one or more competitor companies of the user, results of one or more competitor companies of the user, and/or any combination thereof. Each possibility is a separate embodiment.

According to some embodiments, the method may include comparing between two or more parameters of the extracted data. For example, the method may include comparing between activities of the company of the user and activities of one or more competitor companies of the user.

According to some embodiments, at step 108/158, the method may include generating a user data repository, the user data repository including user specific characteristics, from the extracted data and/or the inputted answers. According to some embodiments, the user data repository may be configured to store data associated with the user's company, such as the data described in greater detail elsewhere herein.

According to some embodiments, the user data repository may include any one or more of the user's inputs and the extracted data. According to some embodiments, the user data repository may include any one or more of the parameters of the extracted data. According to some embodiments, the user data repository may include one or more comparisons of two or more of the parameters of the extracted data. According to some embodiments, the user data repository may include any one or more of the user input, data extracted by the API, processed data resulted from one or more analysis, and/or the actionable insights and/or recommendations. Each possibility is a separate embodiment.

According to some embodiments, generating the user data repository may include applying the expert knowledge module to the inputted answers, thereby determining priorities of the specific user and/or recommended frequency of activity within each channel. According to some embodiments, generating the user data repository may include storing the priorities of the specific user. According to some embodiments, the generating of the user data repository may include storing the comparison of two or more parameters of the extracted data.

According to some embodiments, generating the user data repository may include considering the extracted data in the context of events and/or trends. According to some embodiments, the events and/or trends may include world events and/or trends such as for example, political events and stock market changes. According to some embodiments, the events and/or trends may be professional, such as, for example, an increase in a specific field of work. According to some embodiments, the events and/or trends may include environmental and/or health trends, such as, for example, global warming or a pandemic.

According to some embodiments, the method may include updating the user data repository by first extracting additional data from the internet and/or at least one application program interface (API), based on the plurality of key concepts. According to some embodiments, the additional extracted data may be associated with any one or more of the user's company, company domain, the competitors and/or companies operating in the same or similar domain of the company, or any combination thereof. Each possibility is a separate embodiment.

According to some embodiments, the method may include updating the user data repository and/or the document based, at least in part, on the additional extracted data. According to some embodiments, the method may include updating the user data repository at least once. According to some embodiments, the method may include updating the user data repository daily, weekly, monthly, yearly, and/or any range therebetween. Each possibility is a separate embodiment. According to some embodiments, the method may include updating the user data repository periodically. According to some embodiments, the method may include updating the user data repository continuously.

According to some embodiments, updating the user data repository may include automatically re-extracting data, based on the key concepts (or parameters). According to some embodiments, updating the user data repository may include re-applying the user inputted answers and/or key concepts to the machine learning algorithms. According to some embodiments, updating the user data repository may include processing data resulted from one or more analysis and/or the actionable insights and/or recommendations.

According to some embodiments, at step 110/160, the method may include applying predictive models on the user data repository to establish actionable insights and/or recommendations.

According to some embodiments, the method may include applying one or more algorithms to the user data repository. According to some embodiments, the one or more algorithms may be configured to analyze the data stored in the user data repository. According to some embodiments the one or more algorithms may be configured to generate one or more action plans that have a high probability of succeeding in what the user is aspiring to achieve, thereby producing actionable insights and/or recommendations. According to some embodiments, the one or more algorithms may be configured to generate one or more action plans that have a high probability of succeeding in what the user is aspiring to achieve through marketing. According to some embodiments, the one or more algorithms may use data from the data repository, such as, for example, any one or more of the pre-set goals of the user, past performance of the user's company, and general success metrics provided by the user and/or in the extracted data and/or acceptable market benchmarks. Each possibility is a separate embodiment. According to some embodiments, the method may include storing the actionable insights, recommendations, and/or action plan in the user data repository.

According to some embodiments, the method may include updating a user-data repository configured to store data associated with the company of the user (inputted data and/or extracted data). According to some embodiments, the method may include storing, in the user-data repository, drafts and/or old (or different) versions of the one or more documents. According to some embodiments, the method may include identifying one or more actions taken by the user, based on actions prescribed to the user in one or more action plans and/or prescriptions for marketing strategy. According to some embodiments, the method may include analyzing the effectiveness of the actions taken by the user. According to some embodiments, the method may include analyzing the effectiveness of the actions taken by the user based, at least in part, on the performance and/or outcomes after the actions were taken. According to some embodiments, the method may include utilizing the virtual marketing assistant to store, within the user-data repository, the data and/or analysis associated with the effectiveness of the actions taken by the user.

According to some embodiments, the method may include applying one or more natural language processing (NLP) models on data in the user data repository to produce a document with personalized marketing content, such as depicted by step 161 of FIG. 1B. According to some embodiments, the one or more NLP models may include one or more artificial intelligence AI algorithms. According to some embodiments, the one or more NLP models may include one or more autoregressive language models. According to some embodiments, the one or more NLP may be selected from: Bidirectional Encoder Representations from Transformers (BERT), Robustly Optimized BERT Pretraining Approach (ROBERTa), GPT-3, ALBERT, XLNet, GPT2, StructBERT, Text-to-Text Transfer Transformer (T5), Efficiently Learning an Encoder that Classifies Token Replacements Accurately (ELECTRA), Decoding-enhanced BERT with disentangled attention (DeBERT). Each possibility is a separate embodiment. According to some embodiments, the method may include applying one or more NLP models in the user data repository to produce a document including any one or more of a prescription for marketing strategy, a marketing document, a marketing article and/or a marketing presentation. Each possibility is a separate embodiment. According to some embodiments, the document may be a text document (e.g. a word document) or a slide presentation (e.g. a PowerPoint) or a sheets document (e.g an excel table) According to some embodiments, the method may include combining the one or more NLP models with one or more templates of the selected documents.

According to some embodiments, at step 112/162, the method may include providing the user with one or more documents including the actionable insights and/or recommendations.

According to some embodiments, the document may include a prescription for marketing strategy. According to some embodiments the prescription for marketing strategy (or go-to-market document) may include a recommendation of an action plan for the company, the action plan regarding at least one type of channel for reaching a prospective client and/or a current client. According to some embodiments, the prescription for marketing strategy (or go-to-market document) may include a recommendation of an action plan for the company, the action plan regarding at least one of: an outline including ideas of what to present through a channel, an optimal time (or range thereof) for using the channel, suggested structure outline, suggested content, or any combination thereof. Each possibility is a separate embodiment. According to some embodiments, the channel may include any one or more of a social network, a program, a conference, an email, a blog, a media publication, an ad, a press release, a message, a meeting, or any combination thereof. Each possibility is a separate embodiment. According to some embodiments, the document may include an advertisement, such as, a post or an advertisement message.

According to some embodiments, the prescription for marketing strategy (or go-to-market document) may include a message (or words), generated by the one or more algorithms, wherein the message (or words) includes one or more ideas of what to communicate with clients or prospective clients, through a channel. According to some embodiments, the prescription for marketing strategy may indicate which message to communicate with a specific channel.

According to some embodiments, the prescription for marketing strategy may include a prioritization of usage by the company. According to some embodiments, the prescription for marketing strategy may include a prioritization of the channels available to the user. According to some embodiments, the prescription for marketing strategy may include the recommended frequency of activity within each channel. According to some embodiments, the prescription for marketing strategy may include taking into account the budget of the user's company.

According to some embodiments, the prescription for marketing strategy may include, per channel, an action plan. According to some embodiments, the prescription for marketing strategy may include, per channel, a daily, weekly, and/or monthly action plan. According to some embodiments, the action plan may include an outline of what to present through the channel, an optimal time (or range thereof) for using the channel, suggested content, suggested structure outline or any combination thereof. Each possibility is a separate embodiment.

According to some embodiments, the document may include a marketing document, a marketing article and/or a marketing presentation. According to some embodiments, the marketing document may include an investors deck, one pager, company profile, business plan, marketing plan, competitive analysis, swot analysis, financial plan (or a budget plan), sales deck, marketing deck, two pager, and/or the like. Each possibility is a separate embodiment. According to some embodiments, the document may include an article with content related to the professional field of the user.

According to some embodiments, the document may include one or more passages including ideas and/or concepts associated with the selected document. For example, for a document including a marketing presentation, the one or more passages may include ideas of the value proposition of the user's company. According to some embodiments, the document and/or the passage may include at least 50 words. According to some embodiments, the document and/or the passage may include at least 20 words, at least 30 words, at least 50 words, at least 70 words, at least 100 words, or any range therebetween. Each possibility is a separate embodiment. According to some embodiments, producing a document and/or passage with at least 20 to 100 words means that such document will include viable content for the company.

According to some embodiments, viable content for the company may include any one or more of marketing content and/or one or more action plans. For example, according to some embodiments, the action plan may include a list of one or more conferences, wherein the order in which the conferences are listed may be in order of prioritized conferences. For example, the viable content may include a draft of any one or more of an email, a blog post, a suggested advertisement, the value proposition of the company, a draft post, a suggested script, an article, a message (such as, for example, a short message service (SMS) for SMS marketing). According to some embodiments, the viable content may include one or more images, videos, audio files, and the like. Each possibility is a separate embodiment. According to some embodiments, the one or more algorithms as described herein may be configured to find the images, videos, and/or audio files online. Each possibility is a separate embodiment.

According to some embodiments, the document may be produced (or extracted) in a format selected by the user. According to some embodiments, the document may be downloadable by the user.

According to some embodiments, the method may include receiving, from the user, new and/or adjusted answers to the questionnaire. According to some embodiments, the method may include updating the key concepts based on the new and/or adjusted answers. According to some embodiments, the method may include extracting (new) data based on the new and/or adjusted answers to the questionnaire. According to some embodiments, the method may include storing the (new) extracted data in the user data repository. According to some embodiments, the method may include updating the user data repository based on the new and/or adjusted answers to the questionnaire. According to some embodiments, the method may include updating the one or more selected documents based on the updated user data repository and/or the new and/or adjusted answers to the questionnaire and/or new data extracted from the Internet and/or one or more API's.

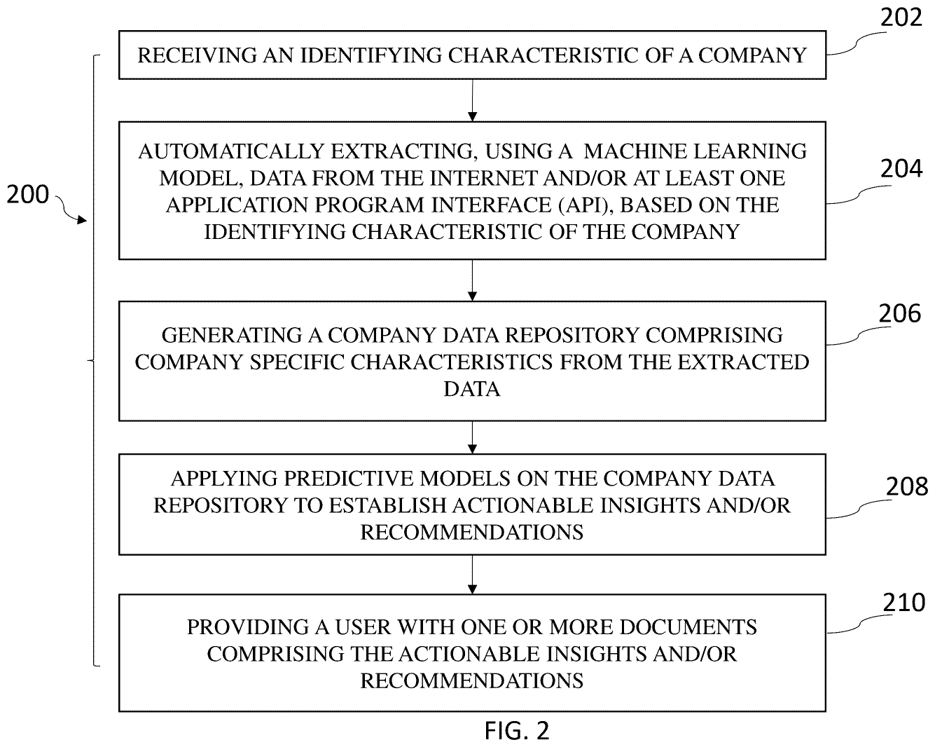

Reference is made to FIG. 2 which shows a schematic block diagram of a method for generation of documents with personalized marketing content, and/or strategy, and/or action plan, in accordance with some embodiments of the present invention.

According to some embodiments, the computer implemented method 200 for generation of documents with personalized marketing content, and/or strategy, and/or action plan may include one or more steps of method 100. According to some embodiments, the method 100 may include one or more steps of the method 200 for generation of documents with personalized marketing content, and/or strategy, and/or action plan.

According to some embodiments, the method 200 may be configured to generate one or more selected document without using data inputted from the user. According to some embodiments, the method 200 may be configured to generate one or more selected document by using only an identifying characteristic of the company of the user. According to some embodiments, the identifying characteristic may include any one or more of the name of the company, the domain of the company, the field of business of the company, or any combination thereof. Each possibility is a separate embodiment.

According to some embodiments, at step 202, the method may include receiving an identifying characteristic of a company. According to some embodiments, at step 204, the method may include automatically extracting, using a machine learning model, data from the internet and/or at least one application program interface (API), based on the identifying characteristic of the company. According to some embodiments, at step 206, the method may include generating a company data repository including company specific characteristics from the extracted data. According to some embodiments, at step 208, the method may include applying predictive models (e.g., artificial intelligence (AI) predictive) on the company data repository to establish actionable insights and/or recommendations. According to some embodiments, at step 210, the method may include providing a user with one or more documents including the actionable insights and/or recommendations.

According to some embodiments, the method may include implementing a virtual marketing assistant. According to some embodiments, the virtual marketing assistant may be configured to prompt the user. According to some embodiments, the virtual marketing assistant may be configured to communicate with the user. According to some embodiments, the method may include displaying and/or outputting data to the user using the virtual marketing assistant. According to some embodiments, the method may include receiving the company name from the user by having the virtual marketing assistant request the company name from the user. According to some embodiments, producing the document may include utilizing the virtual marketing assistant to display the produced document.

According to some embodiments, the method may include utilizing the virtual marketing assistant to monitor the user. According to some embodiments, the method may include utilizing the virtual marketing assistant to monitor performance of the user in implementation of the action plan provided in the one or more documents. According to some embodiments, the method may include utilizing the virtual marketing assistant to send notifications to the user. According to some embodiments, the method may include utilizing the virtual marketing assistant to remind the user to take action based on the documents (or any one or more of the action plan, marketing content and/or strategy provided in the document (or presented by the virtual marketing assistant).

According to some embodiments, the method may include receiving the identifying characteristic of the company from the user. According to some embodiments, the method may include outputting and/or displaying, to the user, one or more options for documents that can be produced. According to some embodiments, the one or more documents may include, but are not limited to, personalized marketing content, and/or strategies and/or action plans for the company of the user. According to some embodiments, the method may include enabling the user to select one or more options for documents. According to some embodiments, the method may include receiving data, from the user, associated with one or more selected documents that are to be produced. According to some embodiments, and as described in greater detail herein, the method includes producing the one or more selected documents.

According to some embodiments, the method for generation of documents with personalized marketing content, and/or strategy, and/or action plan may include generating documents that are personalized to the user and/or the company of the user. According to some embodiments, the method may include generating printable and/or downloadable documents. According to some embodiments, the method may include generating editable documents. According to some embodiments, the documents may be generated in a variety of formats, including, but not limited to, any one or more of: web-based document format, viewable documents, downloadable documents, printable documents or any combination thereof. Each possibility is a separate embodiment. According to some embodiments, the document may include, but is not limited to, any one or more of a prescription for marketing strategy, a marketing document, a marketing article and/or a marketing presentation. According to some embodiments, the one or more documents may include, but are not limited to, an investor deck, one pager, company profile, business plan, marketing plan, competitive analysis, swot analysis, financial plan (or a budget plan), sales deck, marketing deck, two pager, and the like. Each possibility is a separate embodiment. According to some embodiments, the one or more documents may include, but are not limited to, a dynamic document, or in other words, a document that actively updates, such as, for example, a content plan, as described in greater detail elsewhere herein. Each possibility is a separate embodiment. According to some embodiments, the documents may include any one or more of a marketing content, and/or strategy and/or action plan. According to some embodiments, the documents may be associated with inbound and/or outbound and/or brand positioning marketing strategies. According to some embodiments, the documents may be associated with activities within the target market. According to some embodiments, the documents may be associated with any one or more of brand satisfaction and/or business growth.

According to some embodiments, the method may include outputting and/or displaying, to the user, a request for the identifying characteristic of the company. According to some embodiments, at step 202, the method may include receiving an identifying characteristic of a company.

According to some embodiments, at step 204, the method may include automatically extracting, using a machine learning model, data from the internet and/or at least one application program interface (API), based on the identifying characteristic of the company.

According to some embodiments, the method may include extracting data in order to generate the (selected) document. According to some embodiments, the extracted data may be based, at least in part, on the identifying characteristic of the company.

According to some embodiments, the extracted data may be associated with at least one of: the company of the user, one or more clients/prospects of the company of the user, one or more competitors of the company of the user, the professional field of the user's company, the target market of the company of the user, or any combination thereof. According to some embodiments, the extracted data may include one or more parameters including any one or more of: activities of the company of the user, performance of the company of the user, results of the company of the user, activities of one or more competitor companies of the user, performance of one or more competitor companies of the user, results of one or more competitor companies of the user, and/or any combination thereof. Each possibility is a separate embodiment.

According to some embodiments, the method may include comparing between two or more parameters of the extracted data. For example, the method may include comparing between activities of the company of the user and activities of one or more competitor companies of the user.

According to some embodiments, the method may include analyzing, using a machine learning model, the company, by applying an algorithm configured to apply text extraction techniques to the extracted data.

According to some embodiments, the method may include generating, using one or more machine learning models, the key concepts (parameters) based, at least in part, on a cross reference of the inputted answers with data associated with any one or more of: the type of industry, the type of market, and competitor tracking, or any combination thereof. According to some embodiments, the method may include gathering data associated with any one or more of: the type of industry, the type of market, and/or the competitors of the company (or competitor tracking). Each possibility is a separate embodiment. According to some embodiments, the method may include gathering data associated with any one or more of: the type of industry, the type of market, and/or the competitors of the company, using one or more algorithms. According to some embodiments, the method may include gathering data by analyzing the extracted data based on the identifying characteristic of the company, using one or more machine learning models, to determine any one or more of: type of industry, the type of market, and/or the competitors of the company. Each possibility is a separate embodiment. According to some embodiments, the key concepts (parameters) may include any one or more of: one or more insights on the company, one or more strategies, one or more action plans, one or more marketing content, or any combination thereof. Each possibility is a separate embodiment.

According to some embodiments, the method may include utilizing one or more platforms configured to track activities of the user, the user's company, one or more clients of the user, and/or one or more prospective clients of the user (or prospects). Each possibility is a separate embodiment. According to some embodiments, the one or more platforms may include one or more application program interfaces (APIs). According to some embodiments, the method may include tracking various parameters on the activities, performance and results of the user's company and comparable companies.

According to some embodiments, at step 206, the method may include generating a company data repository including company specific characteristics from the extracted data.

According to some embodiments, the user data repository may be configured to store data associated with the user's company, such as the data described in greater detail elsewhere herein.

According to some embodiments, the user data repository may include the extracted data and/or analyzed data. According to some embodiments, the user data repository may include any one or more of the parameters of the extracted data. According to some embodiments, the user data repository may include one or more comparisons of two or more of the parameters of the extracted data. According to some embodiments, the user data repository may include any one or more of the data extracted by the API, processed data resulted from one or more analysis, and/or the actionable insights and/or recommendations.

According to some embodiments, generating the user data repository may include applying an expert knowledge module to the extracted data, thereby determining priorities of the specific user and/or recommended frequency of activity within each channel. According to some embodiments, generating the user data repository may include storing the priorities of the specific user. According to some embodiments, the generating of the user data repository may include storing the comparison of two or more parameters of the extracted data.

According to some embodiments, generating the user-data repository may include taking into account the extracted data in context of events and/or trends. According to some embodiments, the events and/or trends may include world events and/or trends such as for example, political events and stock market changes. According to some embodiments, the events and/or trends may be professional, such as, for example, an increase or decrease in a specific field of work. According to some embodiments, the events and/or trends may include commercial trends, user behavior trends, society trends, health trends, world events and the like, or any combination thereof. Each possibility is a separate embodiment.

According to some embodiments, the method may include updating the user data repository by first extracting additional data from the internet and/or at least one application program interface (API), based on the plurality of key concepts. According to some embodiments, the additional extracted data may be associated with any one or more of the user's company, company domain, the competitors and/or companies operating in the same or similar domain of the company, or any combination thereof. Each possibility is a separate embodiment. According to some embodiments, the method may include updating the user data repository and/or the document based, at least in part, on the additional extracted data. According to some embodiments, the method may include updating the user data repository at least once. According to some embodiments, the method may include updating the user data repository daily, weekly, monthly, yearly, and/or any range therebetween. According to some embodiments, the method may include updating the user data repository periodically. According to some embodiments, the method may include updating the user data repository continuously.

According to some embodiments, updating the user data repository may include automatically re-extracting data, based on the key concepts (or parameters). According to some embodiments, updating the user data repository may include re-applying the identifying characteristic of the company and/or key concepts to the machine learning algorithms. According to some embodiments, updating the user data repository may include processing data resulted from one or more analysis and/or the actionable insights and/or recommendations.

According to some embodiments, at step 208, the method may include applying predictive models on the company data repository to establish actionable insights and/or recommendations.

According to some embodiments, the method may include applying one or more algorithms to the user data repository. According to some embodiments, the one or more algorithms may be configured to analyze the data stored in the user data repository. According to some embodiments the one or more algorithms may be configured to generate one or more action plans that have a high probability of succeeding in what the user is aspiring to achieve, thereby producing actionable insights and/or recommendations. According to some embodiments, the one or more algorithms may be configured to generate one or more action plans that have a high probability of succeeding in what the user is aspiring to achieve through marketing. According to some embodiments, the one or more algorithms may use data from the data repository, such as, for example, any one or more of the pre-set goals of the user, past performance of the user's company, and general success metrics provided by the user and/or in the extracted data and/or accepted industry benchmarks. According to some embodiments, the method may include storing the actionable insights, recommendations, and/or action plan in the user data repository.

According to some embodiments, the method may include updating a user-data repository configured to store data associated with the company of the user (inputted data and/or extracted data). According to some embodiments, the method may include storing, in the user-data repository, drafts and/or old (or different) versions of the one or more documents. According to some embodiments, the method may include identifying one or more actions taken by the user, based on actions prescribed to the user in one or more action plans and/or prescriptions for marketing strategy. According to some embodiments, the method may include analyzing the effectiveness of the actions taken by the user. According to some embodiments, the method may include analyzing the effectiveness of the actions taken by the user based, at least in part, on the performance and/or outcomes after the actions were taken. According to some embodiments, the method may include utilizing the virtual marketing assistant to store, within the user-data repository, the data and/or analysis associated with the effectiveness of the actions taken by the user.

According to some embodiments, and similarly to step 161 of method 150 of FIG. 1B, the method 200 may include applying one or more natural language processing (NLP) models on data in the user data repository to produce a document with personalized marketing content. According to some embodiments, the one or more NLP models may include one or more artificial intelligence AI algorithms. According to some embodiments, the one or more NLP models may include one or more autoregressive language models. According to some embodiments, the one or more NLP may be selected from: Bidirectional Encoder Representations from Transformers (BERT), Robustly Optimized BERT Pretraining Approach (ROBERTa), GPT-3, ALBERT, XLNet, GPT2, StructBERT, Text-to-Text Transfer Transformer (T5), Efficiently Learning an Encoder that Classifies Token Replacements Accurately (ELECTRA), Decoding-enhanced BERT with disentangled attention (DeBERT). Each possibility is a separate embodiment. According to some embodiments, the method may include applying one or more NLP models data in the user data repository to produce a document including any one or more of a prescription for marketing strategy, a marketing document, a marketing article and/or a marketing presentation. According to some embodiments, the method may include combining the one or more NLP models with one or more templates of the selected documents.

According to some embodiments, at step 210, the method may include providing the user with one or more documents including the actionable insights and/or recommendations.

According to some embodiments, the document may include a prescription for marketing strategy. According to some embodiments the prescription for marketing strategy (or go-to-market document) may include a recommendation of an action plan for the company, the action plan regarding at least one type of channel for reaching a prospective client and/or a current client. According to some embodiments, the prescription for marketing strategy (or go-to-market document) may include a recommendation of an action plan for the company, the action plan regarding at least one of: an outline including ideas of what to present through a channel, an optimal time (or range thereof) for using the channel, suggested structure outline, suggested content, or any combination thereof. Each possibility is a separate embodiment. According to some embodiments, the channel may include any one or more of a social network, a program, a conference, an email, a blog, an ad, a press release, a message, a media publication, a meeting, or any combination thereof. Each possibility is a separate embodiment. According to some embodiments, the document may include an advertisement, such as, a post or an advertisement message.

According to some embodiments, the prescription for marketing strategy (or go-to-market document) may include a message (or words), generated by the one or more algorithms, wherein the message (or words) includes one or more ideas of what to communicate with clients or prospective clients, through a channel. According to some embodiments, the prescription for marketing strategy may indicate which message to communicate with a specific channel.

According to some embodiments, the prescription for marketing strategy may include a prioritization of usage by the company. According to some embodiments, the prescription for marketing strategy may include a prioritization of the channels available to the user. According to some embodiments, the prescription for marketing strategy may include the recommended frequency of activity within each channel. According to some embodiments, the prescription for marketing strategy may include taking into account the budget of the user's company.

According to some embodiments, the prescription for marketing strategy may include, per channel, an action plan. According to some embodiments, the prescription for marketing strategy may include, per channel, a daily, weekly, and/or monthly action plan. According to some embodiments, the action plan may include an outline of what to present through the channel, an optimal time (or range thereof) for using the channel, suggested structure outline, suggested content, or any combination thereof. Each possibility is a separate embodiment.

According to some embodiments, the document may include a marketing document, a marketing article and/or a marketing presentation. According to some embodiments, the marketing document may include an investors deck, one pager, company profile, business plan, marketing plan, competitive analysis, swot analysis, financial plan (or a budget plan), sales deck, marketing deck, two pager, and/or the like. Each possibility is a separate embodiment. According to some embodiments, the document may include an article with content related to the professional field of the user.

According to some embodiments, the document may include one or more passages including ideas and/or concepts associated with the selected document. For example, for a document including a marketing presentation, the one or more passages may include ideas of the value proposition of the user's company. According to some embodiments, the document and/or the passage may include at least 50 words. According to some embodiments, the document and/or the passage may include at least 20 words, at least 30 words, at least 50 words, at least 70 words, at least 100 words, or any range therebetween. Each possibility is a separate embodiment. According to some embodiments, producing a document and/or passage with at least 20 to 100 words means that such document will include viable content for the company.

According to some embodiments, viable content for the company may include any one or more of marketing content and/or one or more action plans. For example, according to some embodiments, the action plan may include a list of one or more conferences, wherein the order in which the conferences are listed may be in order of prioritized conferences. For example, the viable content may include a draft of any one or more of an email, a blog post, a suggested advertisement, the value proposition of the company, a draft post, a suggested script, an article, a message (such as, for example, a short message service (SMS) for SMS marketing). According to some embodiments, the viable content may include one or more images, videos, audio files, and the like. According to some embodiments, the one or more algorithms as described herein may be configured to find the images, videos, and/or audio files online. Each possibility is a separate embodiment.

According to some embodiments, the document may be produced (or extracted) in a format selected by the user. According to some embodiments, the document may be downloadable by the user.

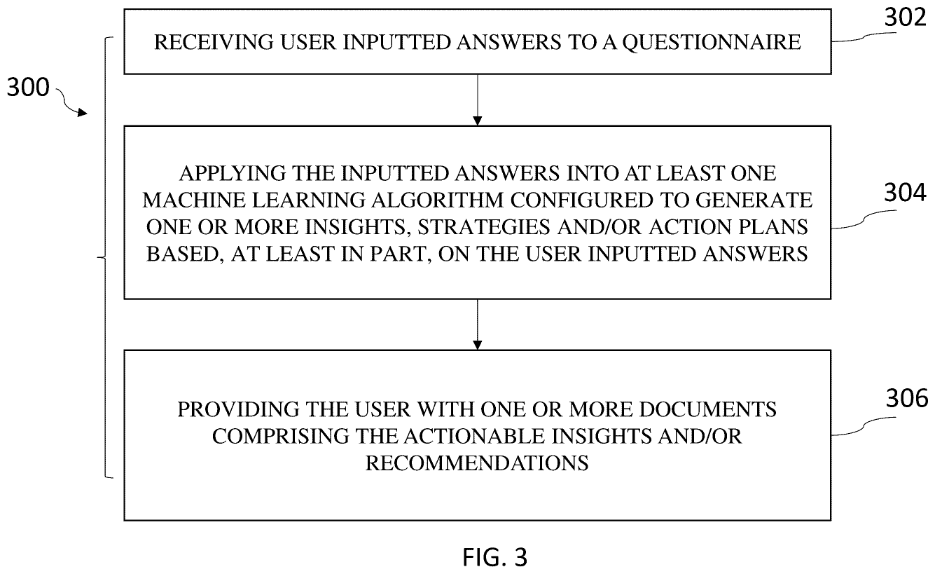

Reference is made to FIG. 3 which shows a schematic block diagram of a method for generation of documents with personalized marketing content, and/or strategy, and/or action plan, in accordance with some embodiments of the present invention.

According to some embodiments, the computer implemented method 300 for generation of documents with personalized marketing content strategy, and/or action plan may include one or more steps of any one or more of the methods 100/200. According to some embodiments, any one or more of the methods 100/200 may include one or more steps of the method 300 for generation of documents with personalized marketing content strategy, and/or action plan.

According to some embodiments, the method 300 may be configured to generate one or more documents with personalized marketing content, and/or strategy, and/or action plan, without utilizing APIs. According to some embodiments, the method 300 may be configured to generate one or more documents with personalized marketing content strategy, and/or action plan, without tracking the user, clients of the company of the user, comparable companies of the user and/or prospective clients of the user.

According to some embodiments, the method may include implementing a virtual marketing assistant. According to some embodiments, the virtual marketing assistant may be configured to prompt the user. According to some embodiments, the virtual marketing assistant may be configured to communicate with the user. According to some embodiments, the method may include displaying and/or outputting data to the user using the virtual marketing assistant. According to some embodiments, the method may include receiving data from the user by having the virtual marketing assistant collect the data from the user. According to some embodiments, the method may include utilizing the virtual marketing assistant to prompt the user to input answers in response to the questionnaire. According to some embodiments, producing the document may include utilizing the virtual marketing assistant to display the produced document.

According to some embodiments, the method may include utilizing the virtual marketing assistant to monitor the user. According to some embodiments, the method may include utilizing the virtual marketing assistant to monitor performance of the user in implementation of the action plan provided in the one or more documents. According to some embodiments, the method may include utilizing the virtual marketing assistant to send notifications to the user. According to some embodiments, the method may include utilizing the virtual marketing assistant to remind the user to take action based on the documents (or any one or more of the action plan, marketing content and/or strategy provided in the document (or presented by the virtual marketing assistant).

According to some embodiments, the method may include receiving user input from a user, wherein the user input may be associated with a company of the user. According to some embodiments, the method may include outputting and/or displaying, to a user, one or more options for documents that can be produced. According to some embodiments, the one or more documents may include, but are not limited to, personalized marketing content, and/or strategies and/or action plans for the company of the user. According to some embodiments, the one or more documents may include, but are not limited to, an investor deck, one pager, company profile, business plan, marketing plan, competitive analysis, swot analysis, financial plan (or a budget plan), sales deck, marketing deck, two pager, and the like. Each possibility is a separate embodiment. According to some embodiments, the one or more documents may include, but are not limited to, a dynamic document, or in other words, a document that actively updates, such as, for example, a content plan, as described in greater detail elsewhere herein. According to some embodiments, the method may include enabling the user to select one or more options for documents. According to some embodiments, the method may include receiving data, from the user, associated with one or more selected documents that are to be produced. According to some embodiments, and as described in greater detail hereinbelow, the method includes producing the one or more selected documents.

According to some embodiments, the method for generation of documents with personalized marketing content, and/or strategy, and/or action plan may include generating documents that are personalized to the user and/or the company of the user. According to some embodiments, the method may include generating printable and/or downloadable documents. According to some embodiments, the documents may be generated in a variety of formats, including, but not limited to, any one or more of: web-based document format, viewable documents, downloadable documents, printable documents or any combination thereof. Each possibility is a separate embodiment. According to some embodiments, the document may include any one or more of a prescription for marketing strategy, a marketing document, a marketing article and/or a marketing presentation. According to some embodiments, the documents may include any one or more of a marketing content, and/or strategy and/or action plan. According to some embodiments, the documents may be associated with inbound and/or outbound and/or brand positioning marketing strategies. According to some embodiments, the documents may be associated with activities within the target market. According to some embodiments, the documents may be associated with any one or more of brand satisfaction and/or business growth.

According to some embodiments, the method may include outputting and/or displaying, to the user, a questionnaire. According to some embodiments, the questionnaire may include one or more questions associated with the company of the user. According to some embodiments, the questions may include any one or more of open-ended questions (such as, for example, text input or free text), single select, multi select, multi-field text input, slider, image, file upload, date and the like or any combination thereof. Each possibility is a separate embodiment.

According to some embodiments, the questionnaire may include one or more question modules, wherein each question module may include one or more different questions. According to some embodiments, the questionnaire may include a plurality of question modules. According to some embodiments, the one or more question modules may include any one or more of an introduction question module, solution question module, business question module, goals question module, financing needs question module, business model question module, market question module, competitors question module, challenges question module, target customers question module, industry type question module buyer persona question module, and the like. Each possibility is a separate embodiment.

According to some embodiments, each of the one or more question modules may include one or more questions. According to some embodiments, each question module may include different questions therein, such that, for example, combining all of the question modules would not result in any repeating questions. According to some embodiments, the one or more questions may be selected from: requesting the company's name, company's webpage, at least one competitor of the company, the size of the company, business model of the company, funding status, the problem, the solution existing alternatives, one or more benefits, business goals, key performance indicators (KPIs), vision, challenges, current market, and/or any combination thereof. Each possibility is a separate embodiment.

For example, the introduction question module may include one or more questions about the business, for examples, the size of the company, the business model, funding status, website, and competitors of the company. For example, the solution question module may include open ended questions about the solution itself, the problem the company is solving, the existing alternatives, the benefits, and the like. Each possibility is a separate embodiment. For example, the goals question module may require the user to set business goals and/or measurable KPIs.

According to some embodiments, the method may include outputting, to the user, a plurality of questions by outputting one or more of the question modules. According to some embodiments, the method may include selecting which question modules to output. According to some embodiments, the method may include selecting (and/or calculating) which question modules to combine, using one or more algorithms, such that no question is repeated. According to some embodiments, the method may include selecting (and/or calculating) which question modules to combine for a specific selected document to be produced. According to some embodiments, the method may include selecting (and/or calculating), using one or more algorithms, which question modules to combine for a plurality of specific selected documents to be produced.

According to some embodiments, at step 302, the method may include receiving user inputted answers to a questionnaire. According to some embodiments, the method may include analyzing, using a machine learning model, the inputted answers, by applying an algorithm configured to apply text extraction techniques to the inputted answers based, at least in part, on an expert knowledge module. According to some embodiments, the expert knowledge module may be an artificial intelligence (AI) based algorithm. According to some embodiments, the expert knowledge module may be part of one or more algorithms that are described in greater detail elsewhere herein.

According to some embodiments, and similarly to step 155 of FIG. 1B, the method 300 may include analyzing the inputted answers by applying text extraction techniques to the inputted answers.

According to some embodiments, the method may include generating, using one or more machine learning models, the key concepts (parameters) based, at least in part, on a cross reference of the inputted answers with data associated with any one or more of the type of industry, the type of market, and competitor tracking, or any combination thereof. According to some embodiments, the method may include gathering data associated with any one or more of the type of industry, the type of market, and/or the competitors of the company (or competitor tracking). Each possibility is a separate embodiment. According to some embodiments, the method may include gathering data associated with any one or more of the type of industry, the type of market, and/or the competitors of the company, using one or more algorithms. Each possibility is a separate embodiment. According to some embodiments, the method may include gathering data by analyzing the inputted answers, using one or more machine learning models, to determine any one or more of type of industry, the type of market, and/or the competitors of the company. Each possibility is a separate embodiment. According to some embodiments, the key concepts (parameters) may include any one or more of: one or more insights on the company, one or more strategies, one or more action plans, one or more marketing content, or any combination thereof. Each possibility is a separate embodiment.

According to some embodiments, at step 304, the method may include applying the inputted answers into at least one machine learning algorithm configured to generate one or more insights, strategies and/or action plans based, at least in part, on the user inputted answers. According to some embodiments, the method may include applying the inputted answers into at least one machine learning algorithm configured to generate one or more insights, strategies and/or action plans based, at least in part, on the plurality of key concepts.

According to some embodiments, the machine learning algorithm may be configured to profile, based on the user inputted answers, any one or more of the clients of the company, prospective clients of the company, one or more competitors of the company of the user, the professional field of the user's company, the target market of the company of the user, the differentiating characteristics of the user's company or any combination thereof.

According to some embodiments, the method may include generating a user data repository, the user data repository including user specific characteristics, from the inputted answers and/or the analyzed inputted answers. According to some embodiments, the user data repository may be configured to store data associated with the user's company, such as the data described in greater detail elsewhere herein.

According to some embodiments, generating the user data repository may include applying an expert knowledge module to the inputted answers, thereby determining priorities of the specific user and/or recommended frequency of activity within each channel. According to some embodiments, generating the user data repository may include storing the priorities of the specific user. According to some embodiments, the generating of the user data repository may include storing the comparison of two or more parameters of the extracted data.

According to some embodiments, generating the user-data repository may include considering the user inputted answers and/or the analyzed inputted answers in context of events and/or trends. According to some embodiments, the events and/or trends may include world events and/or trends such as for example, political events and stock market changes. According to some embodiments, the events and/or trends may be professional, such as, for example, an increase or decrease in a specific field of work. According to some embodiments, the events and/or trends may include commercial trends, user behavior trends, society trends, health trends, world events and the like, or any combination thereof. Each possibility is a separate embodiment.

According to some embodiments, the method may include applying predictive models on the user data repository to establish actionable insights and/or recommendations. According to some embodiments, the method may include applying one or more algorithms to the user data repository. According to some embodiments, the one or more algorithms may be configured to analyze the data stored in the user data repository. According to some embodiments the one or more algorithms may be configured to generate one or more action plans that have a high probability of succeeding in what the user is aspiring to achieve, thereby producing actionable insights and/or recommendations. According to some embodiments, the one or more algorithms may be configured to generate one or more action plans that have a high probability of succeeding in what the user is aspiring to achieve through marketing. According to some embodiments, the one or more algorithms may use data from the data repository, such as, for example, any one or more of the pre-set goals of the user, past performance of the company of the user, and general success metrics provided by the user (or in other words, the user inputted answers) and/or in the analyzed inputted answers and/or acceptable market benchmarks. According to some embodiments, the method may include storing the actionable insights, recommendations, and/or action plan in the user data repository.

According to some embodiments, the method may include updating a user-data repository configured to store data associated with the company of the user (inputted data and/or extracted data). According to some embodiments, the method may include storing, in the user-data repository, drafts and/or old (or different) versions of the one or more documents. According to some embodiments, the method may include identifying one or more actions taken by the user, based on actions prescribed to the user in one or more action plans and/or prescriptions for marketing strategy. According to some embodiments, the method may include analyzing the effectiveness of the actions taken by the user. According to some embodiments, the method may include analyzing the effectiveness of the actions taken by the user based, at least in part, on the performance and/or outcomes after the actions were taken. According to some embodiments, the method may include utilizing the virtual marketing assistant to store, within the user-data repository, the data and/or analysis associated with the effectiveness of the actions taken by the user.

According to some embodiments, and similarly to step 161 of method 150 of FIG. 1B, the method 300 may include According to some embodiments, the method may include applying one or more NLP models on data in the user data repository to produce a document with personalized marketing content. According to some embodiments, the one or more NLP models may include one or more artificial intelligence AI algorithms. According to some embodiments, the one or more NLP models may include one or more autoregressive language models. According to some embodiments, the method may include applying one or more NLP models on data in the user data repository to produce a document including any one or more of a prescription for marketing strategy, a marketing document, a marketing article and/or a marketing presentation. According to some embodiments, the method may include combining the one or more NLP models with one or more templates of the selected documents.

According to some embodiments, at step 306, the method may include providing the user with one or more documents including the actionable insights and/or recommendations.

According to some embodiments, the document may include a prescription for marketing strategy. According to some embodiments the prescription for marketing strategy (or go-to-market document) may include a recommendation of an action plan for the company, the action plan regarding at least one type of channel for reaching a prospective client and/or a current client. According to some embodiments, the prescription for marketing strategy (or go-to-market document) may include a recommendation of an action plan for the company, the action plan regarding at least one of: an outline including ideas of what to present through a channel, an optimal time (or range thereof) for using the channel, suggested structure outline, suggested content, or any combination thereof. Each possibility is a separate embodiment. According to some embodiments, the channel may include any one or more of a social network, a program, a conference, an email, a blog, an ad, a press release, a message, a media publication, a meeting, or any combination thereof. Each possibility is a separate embodiment. According to some embodiments, the document may include an advertisement, such as, a post or an advertisement message.

According to some embodiments, the prescription for marketing strategy (or go-to-market document) may include a message (or words), generated by the one or more algorithms, wherein the message (or words) includes one or more ideas of what to communicate with clients or prospective clients, through a channel. According to some embodiments, the prescription for marketing strategy may indicate which message to communicate with a specific channel.

According to some embodiments, the prescription for marketing strategy may include a prioritization of usage by the company. According to some embodiments, the prescription for marketing strategy may include a prioritization of the channels available to the user. According to some embodiments, the prescription for marketing strategy may include the recommended frequency of activity within each channel. According to some embodiments, the prescription for marketing strategy may include taking into account the budget of the user's company.

According to some embodiments, the prescription for marketing strategy may include, per channel, an action plan. According to some embodiments, the prescription for marketing strategy may include, per channel, a daily, weekly, and/or monthly action plan. According to some embodiments, the action plan may include an outline of what to present through the channel, an optimal time (or range thereof) for using the channel, suggested structure outline, suggested content, or any combination thereof.

According to some embodiments, the document may include a marketing document, a marketing article and/or a marketing presentation. According to some embodiments, the marketing document may include an investors deck, one pager, company profile, business plan, marketing plan, competitive analysis, swot analysis, financial plan (or a budget plan), sales deck, marketing deck, two pager, and/or the like. Each possibility is a separate embodiment. According to some embodiments, the document may include an article with content related to the professional field of the user.

According to some embodiments, the document may include one or more passages including ideas and/or concepts associated with the selected document. For example, for a document including a marketing presentation, the one or more passages may include ideas of the value proposition of the user's company. According to some embodiments, the document and/or the passage may include at least 50 words. According to some embodiments, the document and/or the passage may include at least 20 words, at least 30 words, at least 50 words, at least 70 words, at least 100 words, or any range therebetween. Each possibility is a separate embodiment. According to some embodiments, producing a document and/or passage with at least 20 to 100 words means that such document will include viable content for the company. According to some embodiments, the document may be produced (or extracted) in a format selected by the user. According to some embodiments, the document may be downloadable by the user.

According to some embodiments, the method may include receiving, from the user, new and/or adjusted answers to the questionnaire. According to some embodiments, the method may include updating the key concepts based on the new and/or adjusted answers. According to some embodiments, the method may include analyzing the new user inputted answers. According to some embodiments, the method may include updating the user data repository based on the new and/or adjusted answers to the questionnaire. According to some embodiments, the method may include updating the one or more selected documents based on the updated user data repository and/or the new and/or adjusted answers to the questionnaire.

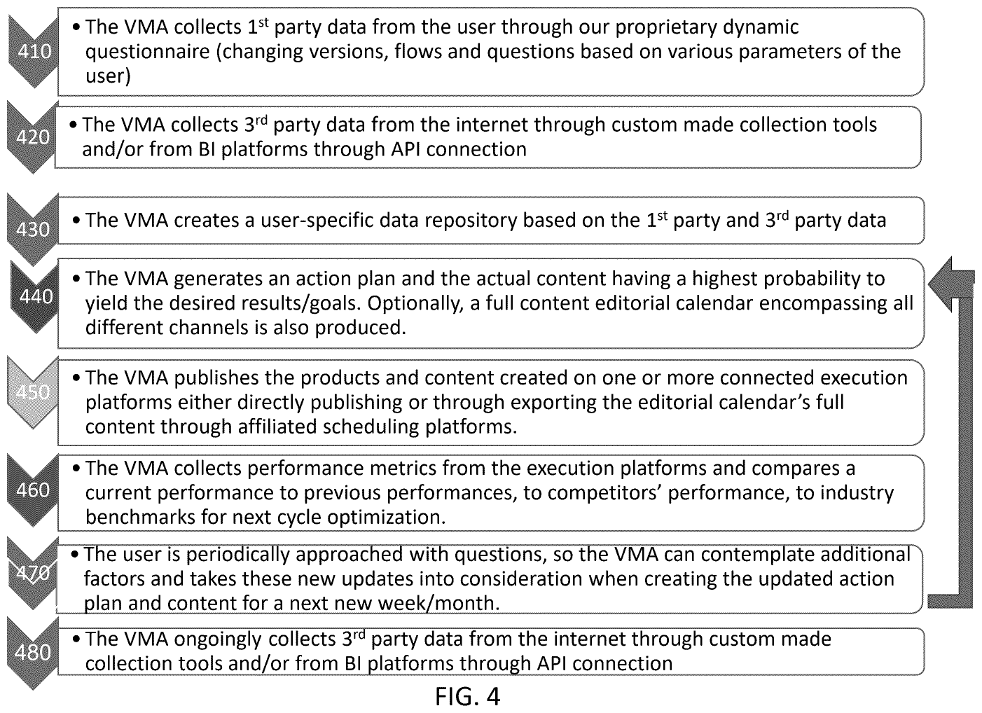

Reference is made to FIG. 4, which shows a flowchart 400 of a computer implemented method for generation of a personalized marketing content, strategy, and action plan, in accordance with some embodiments of the present invention. It is understood that while the actual flow of at least some of the steps may be conducted in the below depicted order, a different flow of at least some of the steps can also be envisaged. For example, some steps may be carried simultaneously with preceding or successive steps. Furthermore, some steps may at certain instances be obviated. For example, evaluative steps (such as step 460 may not be carried out when launching the use of the platform.

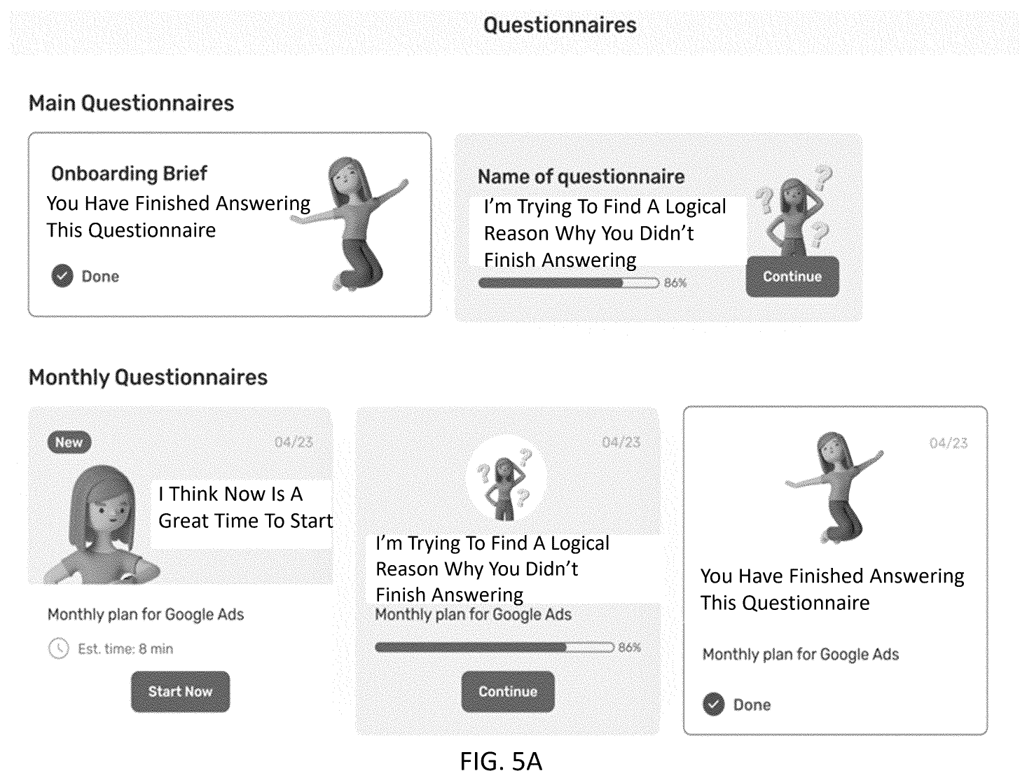

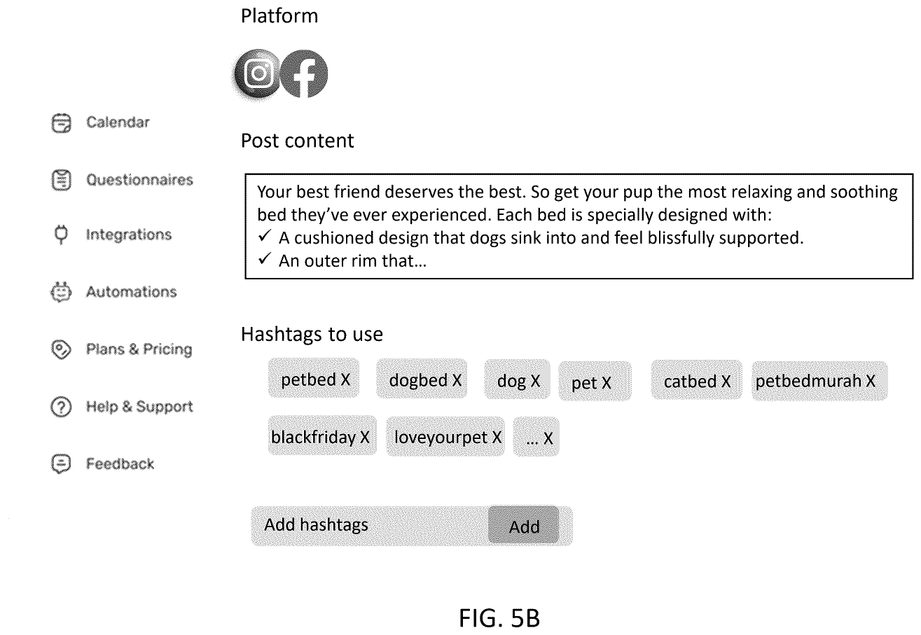

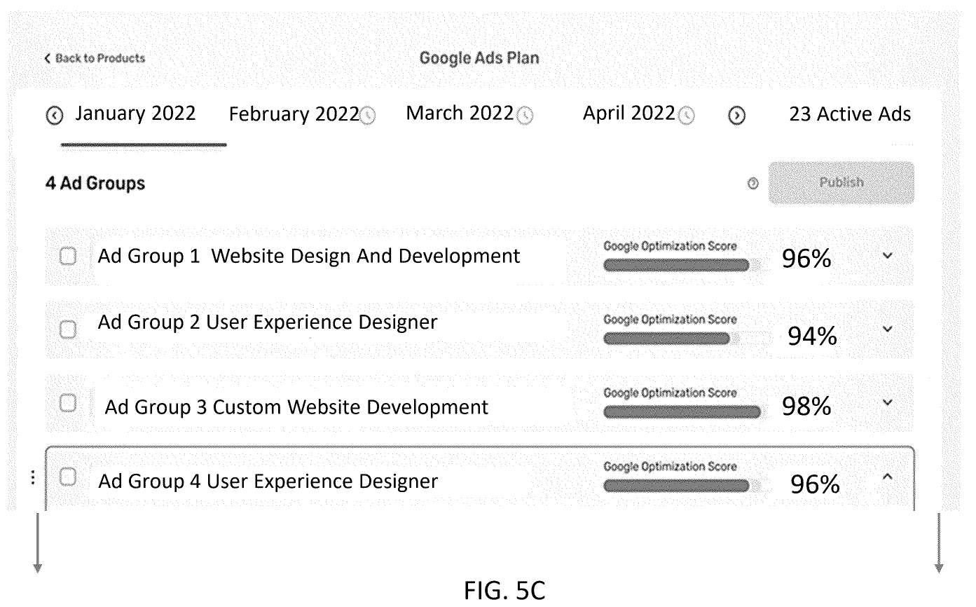

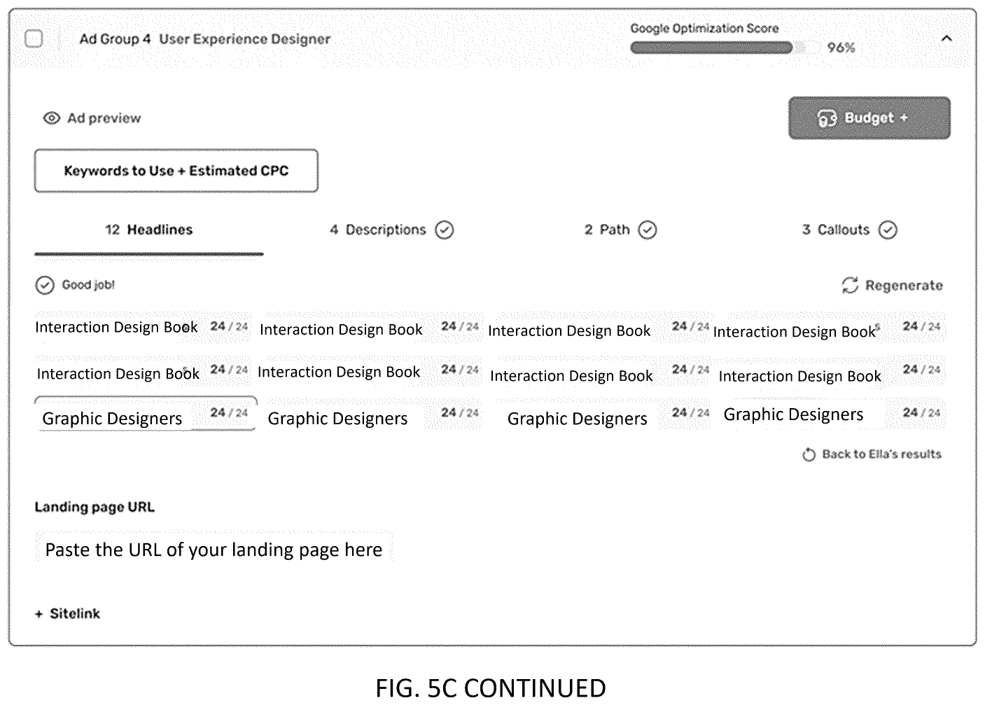

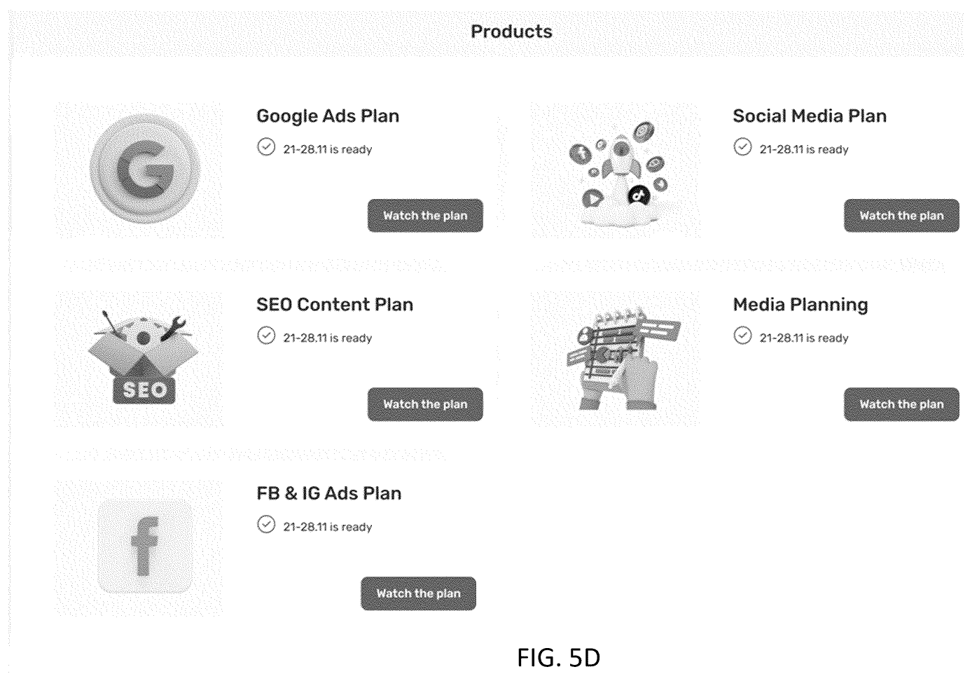

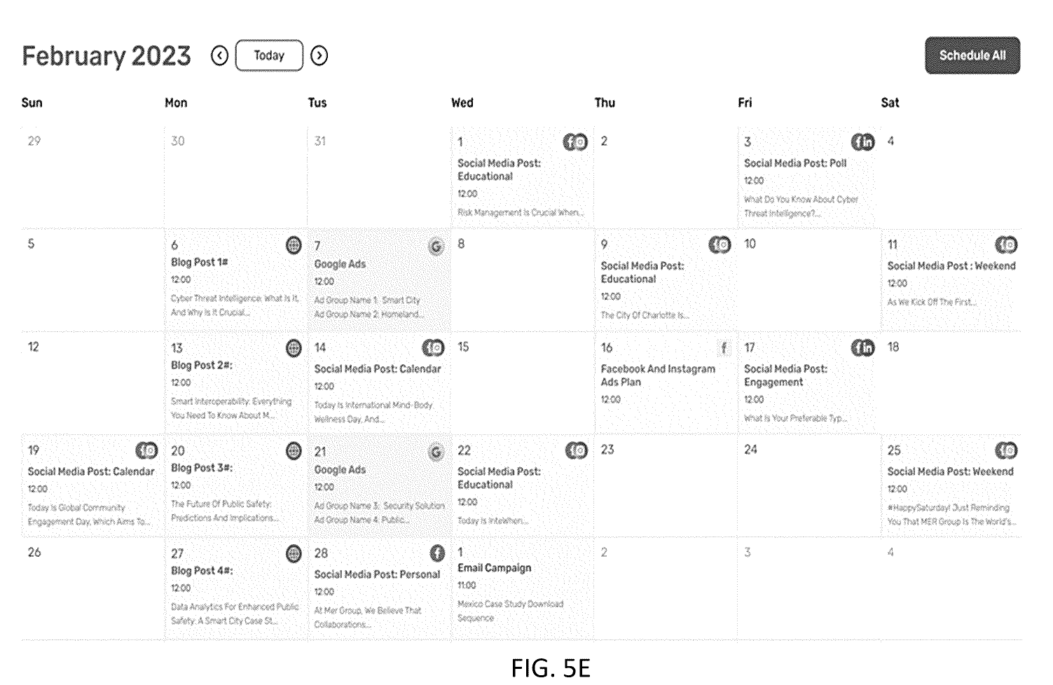

In step 410, also referred to as 1^{st} party data collection, data is collected, via a digital platform interface, from a user. According to some embodiments, the data is collected via a questionnaire (as shown in FIG. 5A). According to some embodiments, the questionnaire may be an onboarding questionnaire configured to gather basic information about a business, the market, the target audience, the team, the competitors, their activities, marketing channels and/or the like and may include collection of data through text, voice or other input method. Each possibility is a separate embodiment. According to some embodiments, the questionnaire may be dynamic e.g. in terms of changing versions, flows and questions, as further elaborated herein. According to some embodiments, the questionnaires responses may be analyzed using one or more NLP models configured to extract key features and characteristics therefrom.

Additionally or alternatively, in step 420, 3^{rd} party data may be retrieved from the internet and/or through one or more APIs. This information can include information about the business, the market, the target audience, the team, the competitors, their activities, marketing channels, performance and/or the like. Each possibility is a separate embodiment. According to some embodiments, the 3^{rd} party data retrieved is processed using one or more NLP models and/or classification modules.

In step 430, a data repository is created based on the 1^{st} and/or 3^{rd} party data retrieved and processed. According to some embodiments, the data repository may constantly be updated with real time data. According to some embodiments, the data repository may be updated based on user-initiated updates to the questionnaire answers. Additionally, or alternatively, the data repository may be updated based on requests prompted via a user interface or the like to update at least a portion of the answers to the questionnaire e.g. in a rolling monthly questionnaire (as shown in FIG. 5A). Additionally or alternatively, the data repository may be updated based on newly collected 3^{rd} party data. Additionally or alternatively, the data repository may be updated based on performance data obtained for example from connected 2^{nd} party sources, such as google ads, google analytics, email distribution systems, social media insights, and the like).

In step 440 an action plan, along with its actual content, is generated by the VMA by applying machine learning algorithms, such as reinforced learning algorithms on the data repository and optionally on one or more business goals. According to some embodiment, the algorithm outputs a set of decision-making parameters. According to some embodiment, the algorithm comprises predictive and/or prescriptive analytics. According to some embodiments, the action plan includes more than one action plan. According to some embodiments, the action plan may for example include one action plan for social media actions (as shown in FIG. 5B) and one action plan for advertisement (e.g. Google Ads), as shown in FIG. 5C). It is understood that the action plan may include various products and/or outputs (FIG. 5D) and combinations thereof.

Advantageously, the content may be created proactively, in an ongoing manner, such that the user continuously/periodically receives a flow of high plans and content designed to progress him/her toward defined goals. To clarify-no prompting or active directions are required from the user in order to create the content in an ongoing manner. The VMA is the researcher and the initiator of the content ideas and the creator of the content without any need for user intervention. The VMA also reinforces its learnings through actively tracking performance of past content created and released to the user, and/or from any edits made by the user to said content such that it continuously adjust, adapts and improved on an autonomous basis.

According to some embodiments, custom transformer models, e.g. open source models such as GPT-J, that are trained and fine-tuned using collected data and tagged using human feedback/expert knowledge. According to some embodiments, Reinforcement Learning GPT J may be used as a part of the training processes using customized datasets and unique transformer models. According to some embodiments, different marketing products may be fine-tuned using different models to generate the action plan and/or content. For example, a specific action plan can be generated by multiple models some of which may be machine learning based to predict certain action classes (i.e. post type such as Video/Carousel/Poll etc.) and in addition one or more generative deep learning models to generate the contents of the plan i.e. post text. According to some embodiments, the models may be continuously improved using reinforcement learning, as more data is collected over time, based on a human feedback loop, and/or an automatic performance-based feedback loop.

According to some embodiments, Machine Learning (tabular data) predictive models may be applied on the data repository to predict what action plan and content will be most efficient in achieving a predetermined goal.

According to some embodiment, the action plan may for example include one or more channels used for publishing marketing content, a frequency of the publishing, a priority of the publishing, a type of marketing publishing or any combination thereof. Each possibility is a separate embodiment. Based on the data repository, the actual content for each channel is likewise generated based on a calculated highest probability of yielding a desired results or achieving a desired goal. According to some embodiments, a full content editorial calendar encompassing all different channels is also generated. An exemplary such calendar is shown in FIG. 5E. According to some embodiments, the calendar is a content calendar that has personal, original, well-crafted content for each channel, pre-scheduled for execution. That is, for each month the user may receive the full content for all channels with suggested execution dates, prescheduled based on optimal dates and time frames, ready for approval. According to some embodiments, the calendar enables scheduling and pushing content either directly or through 2nd party platforms, such as but not limited to Canva, Hootsuit, Later, Buffer, etc. Each possibility is a separate embodiment. This translates to the user having a full month's worth of marketing action plans and content already pre-scheduled to serve as a full editorial calendar of all his planned marketing activities.

According to some embodiments, the action plan and/or the content generated may be routinely updated based on updates in the data repository and/or based in changed, adjusted or added business goals.

According to some embodiments, the business goals may be user-provided. Additionally or alternatively, the business goals may be determined by the VMA algorithm, based on industry benchmarks, general best practices and/or expert knowledge. Each possibility is a separate embodiment.

In step 450, the content is then published on one or more connected or not connected execution platforms. Non-limiting examples of suitable execution platforms include Google Ads, Facebook, Instagram, Hubspot, Hootsuite, MailChimp or the like. Each possibility is a separate embodiment. According to some embodiments, the various platforms may be accessible through the user interface of the VMA platform, such that all channels can be managed via the VMA platform.

According to some embodiment, the publishing may be direct publishing. According to some embodiment, the publishing may be indirect, e.g. via exporting of the full content of the editorial calendar through affiliated scheduling platforms, such as, but not limited to Canva, Hootsuite, Later, Buffer, or the like). According to some embodiments, the publishing may be automatic. According to some embodiments, the publishing may be manually performed by the user. According to some embodiments, the publishing may be prepared but require a user-approval for its actual execution.

According to some embodiments, the platform facilitates creation of various types of content from text content generation to different media formats (instructional or auto generation). According to some embodiments, the media may be selected and/or modified

In step 460, performance metrics are automatically collected from the execution platforms (2^{nd} party data) and compared to a previous performance, to competitors' performance, to industry benchmarks and the like, in light of the set business goals and/or in light of actions actually taken (out of total planned). Each possibility is a separate embodiment.

In step 470, the platform may proactively and/or periodically request to answer one or more follow up questions and/or to re-answer some questions from the questionnaire (e.g. regarding new products, intended sale offers etc.), in order to optimize a next issued action plan and/or content.

In step 480, the machine learning algorithm creating the action plan and content may be fed with the 2^{nd} party data and/or the updated questions to adjust a current action plan and/or content or to optimize the generation of a future action plan and/or content. According to some embodiments, the adjustments and/or optimization are incurred proactively and automatically by the VMA on an ongoing basis.

Furthermore, according to some embodiments, the user may edit the action plan and/or the content. According to some embodiments, each such edit/change may induce an automatic update of the data repository and thus in the input fed to the machine learning algorithm (continuous training of the algorithm).

According to some embodiments, the VMA has autonomous ongoing decision-making, content creation, and management capabilities within a pre-defined “playground”, meaning that it shall have the capabilities to launch and/or terminate campaigns, generate, change/update content, shift between channels, etc.—all within a pre-defined budget and aimed at facilitation of the business goals—on an ongoing basis on behalf of the user.

According to some embodiments, the VMA is proactive, i.e. it actively initiates what needs to be done, when, how, why, including proactive creation of all the plans and content in an ongoing manner, such that the user continuously/periodically receives a flow of high quality, personalized, original plans and content designed to progress him/her toward defined goals. To clarify—no prompting or active directions are required from the user in order to create the content in an ongoing manner. The VMA is the researcher and the initiator of the content ideas and the creator of the content without any need for user intervention. The VMA also reinforces its learnings through actively tracking performance of past content created and released to the user, and/or from any edits made by the user to said content such that it continuously adjust, adapts and improved on an autonomous basis.

According to some embodiments, the VMA is trained to provide ongoing, proactive, self-initiated and comprehensive full-stack marketing management, planning, creation and execution capabilities to businesses at any size or stage, within any budget and in different channels and methods.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

As used herein, the terms “one or more” and “at least one” may be used interchangeably and refer to 1, 2, 3, 4, 5 or more of the item/feature to which they refer.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer (or cloud) may be connected to the user's computer through any type of network, including a local area network (LAN) or a wide area network (WAN), or the connection may be made to an external computer (for example, through the Internet using an Internet Service Provider) including wired or wireless connection (such as, for example, Wi-Fi, BT, mobile, and the like). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A virtual marketing assistant (VMA) platform comprising a user interface and processor configured to:
receive, via the user interface user inputted answers to a questionnaire;
analyze, using a natural language model, the inputted answers and extracting therefrom a plurality of key concepts (parameters);
automatically extract data, from the internet and/or at least one application program interface (API), based on the plurality of key concepts;
generate a user-specific data repository, the user-specific data repository comprising user specific characteristics, from the extracted data and/or the inputted answers; and
apply one or more predictive and generative Machine or Deep learning models on the user-specific data repository to automatically generate a digital marketing action plan and associated content.

2. The platform of claim 1, wherein the processor is further configured to execute the action plan via one or more associated execution platforms.

3. The platform of claim 2, wherein the processor is further configured to collect performance data from the one or more associated execution platforms and updating the user-specific data repository based on the collected performance data.

4. The platform of claim 1, wherein the processor is further configured to prompt the user with one or more additional questions and updating the user-specific data repository based on answers to the one or more additional questions.

5. The platform of claim 1, wherein generating the content for the action plan comprises applying one or more natural language processing (NLP) models on the user data repository to produce an output with personalized marketing content.

6. The platform of claim 5, wherein the output is selected from a text document, a blog, an email, an ad, a social media post, investor deck, one pager, company profile, business plan, marketing plan, competitive analysis, swot analysis, financial plan and any combination thereof.

7. The platform of claim 1, wherein generating the action plan comprises applying a reinforcement learning algorithm on the user-specific data repository.

8. The platform of claim 1, wherein the action plan comprises one or more actions selected from posting on social media, sending an email, uploading/creating a blog, uploading a virtual advertisement or any combination thereof.

9. The platform of claim 1, wherein generating an action plan comprises selecting one or more channels for publishing the generated content, wherein the one or more channels comprise any one or more of a social network, a program, a conference, an email, a blog, an ad, a press release, a message, a media publication, a meeting, or any combination thereof.

10. The platform of claim 9, wherein generating an action plan comprises identifying the best channel, an optimal timing and/or frequency of activity within each channel.

11. The method of claim 1, wherein the key concepts comprise any one or more of: one or more insights on the company, one or more strategies, one or more action plans, one or more marketing content, one or more business goals or any combination thereof.

12. The platform of claim 1, wherein the extracted data is associated with at least one of: the company of the user, one or more clients/prospects of the company of the user, one or more competitors of the company of the user, the professional field of the user's company, the target market of the company of the user, or any combination thereof.

13. The platform of claim 1, wherein the extracted data comprises parameters comprising any one or more of: activities of the company of the user, performance of the company of the user, results of the company of the user, activities of one or more competitor companies of the user, performance of one or more competitor companies of the user, results of one or more competitor companies of the user, and/or any combination thereof.

14. The platform of claim 1, wherein generating the user data repository comprises comparing two or more parameters of the extracted data.

15. The platform of claim 1, wherein the questionnaire comprises a plurality of open-ended questions.

16. The platform of claim 1, wherein the questionnaire comprises one or more question modules, wherein each question module comprises one or more different questions.

17. The platform of claim 16, wherein one or more of the question modules comprises one or more questions selected from: requesting the company's name, company's webpage, at least one competitor of the company, the size of the company, business model of the company, funding status, the problem, the solution existing alternatives, one or more benefits, business goals, key performance indicators (KPIs), vision, challenges, current market, and/or any combination thereof.

18. The platform of claim 1, wherein generating the user data repository comprises applying an expert knowledge module and a reinforcement learning algorithm on the inputted answers.

19. The platform of claim 1, wherein the processor is further configured to update the user data repository by extracting additional data from the internet and/or at least one application program interface (API), based on the plurality of key concepts.

20. The platform of claim 19, wherein the processor is further configured to update the user data repository and/or the output based, at least in part, on the additional extracted data.

21. The platform of claim 1, wherein the processor is further configured to receive, from the user, new and/or adjusted answers to the questionnaire, and updating the key concepts, the output and/or the data repository, based on the new and/or adjusted answers.
